(19) United States
(12) Patent Application Publication
(10) Pub. No.: US 2003/0089759 A1
(43) Pub. Date: May 15, 2003

(54) Surface treatment method for a cylinder head and a cylinder head to which the surface treatment has been applied

(75) Inventors: Hiroaki Kusunoki, Aki-gun (JP); Tsutomu Masuda, Aki-gun (JP)

Correspondence Address: NIXON PEABODY, LLP, 8180 GREENSBORO DRIVE, SUITE 800, MCLEAN, VA, 22102, US

(73) Assignee: MAZDA MOTOR CORPORATION, Hiroshima (JP)

(21) Appl. No.: 10/270,076

(22) Filed: Oct. 15, 2002

(30) Foreign Application Priority Data
Oct. 15, 2001 (JP) 2001-316593
Aug. 5, 2002 (JP) 2002-227757

(51) Int. Cl. B23K 20/12

(52) U.S. Cl. 228/112.1

(57) ABSTRACT

The invention provides a surface treatment method for a light alloy cylinder head of a multiple cylinder engine having a plurality of intake and exhaust ports for each cylinder wherein the method improves treatment efficiency and restrains dispersion in cylinders when surface treatment by the frictional stirring treatment is applied to surface parts between said intake and exhaust ports, and wherein a treating path of the frictional stirring treatment is independently set for each cylinder and the pattern of the treating path is substantially the same for all cylinders, and forward and backward paths are set in each treating path, thereby. the surface treatment is continuously executed for each cylinder from a treatment start portion to an end portion in the pattern of the treating path.

### BACKGROUND OF THE INVENTION

1. Field of the Invention

The present invention relates to a surface treatment method for a cylinder head and a cylinder head to which the surface treatment has been applied, and more particularly to a surface treatment method for a cylinder head wherein a frictional stirring treatment is applied, using a predetermined rotational tool, to at least a surface part between intake and exhaust ports of a light alloy cylinder head of an engine provided with cylinders having a plurality of intake and exhaust ports and to a cylinder head to which the surface treatment has been applied.

2. Description of the Prior Art

As is commonly known, for example, a cylinder head of an engine for a vehicle such as for an automobile is generally made of a casting whose material is a light alloy material such as aluminum (Al) or its alloy, and such a cylinder head is assembled in a cylinder block to be used.

Recently, a vehicle engine of a multiple cylinder type such as a two cylinders' or a four cylinders' which has a plurality of intake and exhaust ports for each cylinder is popularly used, and a type of a cylinder head to which a glow plug is mounted between intake and exhaust ports is generally used for example in a diesel engine and the like.

In such cylinder head, since an area between port holes of intake and exhaust ports that is the so-called “valve bridge portion” or “space between valve ports” repeats cubical expansion due to combustion at cylinders during the engine driving and volumetric shrinkage due to cooling during the engine stop, in general, a crack due to thermal fatigue tends to occurs there. With respect to this problem, conventionally, the so-called remelt treatment has been performed for the space between valve ports to improve the thermal fatigue strength.

However, this remelt treatment imposes a restriction on a depth which is capable of being treated, since a shoulder die wear is caused due to the small heat capacity of the space between valve ports, when an amount of heat input is increased for the purpose of increasing the depth of treatment such that the depth is adapted to an increase of the thermal load applied to the cylinder head. In addition, increasing the amount of heat input results in a long solidification time, so that the effect of making the texture finer becomes less and pin-hole defects tend to increase. Thereby, the surface reforming effect due to the increase of the treating depth is cancelled out, so that it becomes difficult to obtain the intended effect of improving the heat resistance.

Further, increasing the amount of heat input also results in the easy occurrence of a crack in a member due to thermal stress during the remelt treatment, so that the member is required to be pre-heated. In addition, there are problems such as one that in a material containing magnesium, magnesium evaporates to be decreased at the time of melting, the improvement of the strength becomes small due to T6 heat treatment (solution treatment and aging treatment) after the remelt treatment, and thus a required mechanical characteristic cannot be obtained.

Moreover, regarding quality, it is considerably hard to ensure the quality stability of the treated portion since the treatment depth is largely varies due to the variations in the amount of heat input and a displacement caused by magnetic arc blow and since pin-hole defects in the treated portion are influenced by the gas content in a base material and blowhole area.

Furthermore, with respect to productivity, a shielding gas is required for preventing the melting portion from being oxidized because the treating portion is to be melted, and further a process to remove a cast surface prior to processing is often added in order to prevent the occurrence of gas defect due to a gas generated from a surface oxide and an impurity. Moreover, since a post heat treatment is necessary in order to release a high tensile residual stress generated in a treated portion surface, the cost reduction becomes a problem.

Meanwhile, as a surface treatment method for a light metal member made of aluminum, its alloy, or the like, known is the so-called frictional stirring treatment wherein a rotational tool which rotates at high speeds is caused to come into contact with the member surface so that the rotational tool is moved along the surface while maintaining a pressing condition against the surface, whereby the quality of said member surface and the vicinity thereof is improved to enhance its mechanical characteristics.

For example, Japanese Patent Laid-Open Publication No. 2000-15426 discloses that such frictional stirring treatment is applied to surface treatment of a sealing surface (mating face) with a cylinder block of an aluminum alloy cylinder head of an engine.

In the above-mentioned frictional stirring treatment method, a rotational tool which rotates at high speeds is caused to abut the member surface to press it, so that by frictional heat generated at that time and by an agitation function of the rotational body, a portion of the member surface abutting the rotational tool and the vicinity thereof are softened so that a plastic flow occurs. Then, the material part (plastic flow layer) in the present plastic condition is stirred without melting, followed by cooling of the plastic flow part, whereby the quality of the surface of said member and the vicinity thereof is improved.

By applying a surface improving treatment by this frictional stirring treatment to a surface of a casting member made of a light metal such as an aluminum alloy, the metal structure of the surface part of a casting member becomes finer, in comparison with a case by the so-called remelt treatment and the like in which a surface part is melted to improve the quality thereof, and internal unfilled defects due to blowhole or the like can be drastically reduced. Thereby, mechanical characteristics such as elongation, toughness, and the like and fatigue strength (thermal fatigue strength) can be improved. In this case, there is no risk that blowhole or pin hole due to a gas or the like inside a casting member is formed as in the case where a surface part is melted by the remelt treatment or the like to improve the quality thereof.

Thus, the present applicant has proposed in Japanese Patent Application No. 2000-393328 that such frictional stirring treatment method is applied to a surface quality improving treatment for regions between intake and exhaust ports (space between valve ports) of a light alloy cylinder head of a multiple cylinder engine.

According this prior art, in an aluminum alloy cylinder head of an engine with a series of four cylinder provided with a pair of intake ports and a pair of exhaust ports for each cylinder, a fictional stirring treatment is applied to a surface part of the space between valve ports of each cylinder which is approximately cross-shaped. In the fictional stirring treatment, a treating path corresponding to a movement locus of the rotational tool is structured with four relatively short treating paths which are provided for each cylinder and which extend in the width direction of the cylinder head and one long treating path which extends in the longitudinal direction of the cylinder head, running through all cylinders.

The surface treatment for the space between valve ports of the intake and exhaust ports of four cylinders along those treating paths is conducted through a series of processes. In this case, more preferably, a forward and backward paths is predetermined in each treating path, and surface treatment by the frictional stirring treatment is repeatedly applied to each space between valve ports at both forward and backward paths, in order to achieve more effective quality improvement of the surface part of each space between valve ports, covering its entire width.

Meanwhile, in the above-described frictional stirring treatment method, a deep end hole is left unavoidably at an end portion of a treating path when the surface treatment is finished with the treating path, since an abutting portion of the treated member with the rotational tool becomes deeper when the movement of the rotational tool is stopped to be pulled. In order that this end hole is not left in a product of a completed state finally, it is necessary to set a position of the end hole at a position on which the hole is to be completely removed by processing of a post-process after the surface treatment. In other words, it is necessary to extend the treating path of the frictional stirring treatment up to such a position to move the rotational tool (hereafter, such treatment is referred to as “end hole treatment”).

Accordingly, in order to improve treatment efficiency of a surface refining treatment by the frictional stirring treatment method, it is required to shorten the time spent in such end hole treatment as much as possible.

However, in the above-described prior art, for implementing surface treatment for space between valve ports of four cylinders, a treating path running through all cylinders is set in addition to treating paths for the respective cylinders, that is, totally five treating paths are set. Therefore, the end hole treatments of the rotational tool are required at totally five portions.

Further, in a surface treatment along one long treating path extending in the longitudinal direction of the cylinder head, running through all cylinders, useless treatment time has to be spent, since the rotational tool moves even on a surface of a space between cylinders for which the surface treatment is not required.

Further more, in the case where a forward path and a backward path are set in the long treating path running through all cylinders, in a vicinity of a portion where the rotational tool makes a turn from the forward path to the backward path (accordingly at the cylinder of the cylinder head end which is nearest to this turning portion), since treatment in the backward path is performed nearly superposing on the treatment in the forward path before a region treated in the forward path is cooled, the treatment depth of such region becomes considerably deep compared with other treated regions (that is, compared with other cylinders). That is, the prior art has a drawback in that dispersion in the treatment depth of the surface treatment occurs among plural cylinders.

Meanwhile, in a case that a treating path set to a space between valve ports is provided with a forward path and a backward path in parallel to each other, it may be considered to set a turning path connecting a end point of the forward path with a start point of the backward path as a turning portion to change the moving direction of the rotational tool by 90 degrees Thereby, it is possible to move the rotational tool continuously and to improve the efficiency of the surface treatment.

However, in a vicinity of the turning path, since treatment in the backward path is performed nearly superposing on the treatment in the forward path before a region treated in the forward path is cooled, the temperature of such region becomes considerably high. Specifically, in the turning portion, since the rotational tool continues to rotate although the travelling of the same is stopped temporarily, the temperature of such portion becomes still higher. Further, in a vicinity of the turning path, since there exist two tuning portions, the temperature of such region becomes still further higher. More specifically, in a surface treatment for a space between valve ports of the cylinder head, it is desired that the treatment is applied to a portion as near a port end as possible. Therefore, the above-mentioned forward and backward paths are preferably set in the vicinity of intake and exhaust ports. However, in the case that the forward and backward paths are set in such a way, each turning portion is to be located in the vicinity of the valve port. Accordingly, the temperature of such region becomes still higher.

As a result, the temperature of the region adjacent to the turning path is raised unnecessarily, and there is a fear that deformation occurs in a shoulder portion and the like of the port end and the vicinity thereof. The deformation of the port end causes to hinder the sufficient frictional stirring inside the material, and thereby causing unfilled defects inside a treated region.

### SUMMARY OF THE INVENTION

The present invention has been made in consideration of the above-described problems, and it is a major object of the present invention to provide a surface treatment method by which the treatment efficiency can be improved and the dispersion of treatment depth between cylinders can be restrained, in applying the surface treatment by the frictional stirring treatment to a surface part between intake and exhaust ports of a light metal cylinder head.

Another major object of the present invention is to restrain the generation of unfilled defects inside a treated region by the deformation of the port end in the above-mentioned surface treatment.

Also, it is a major object of the present invention to provide a cylinder head to which such surface treatment has been applied.

In accordance with a first aspect of the present invention, there is provided a surface treatment method for a light alloy cylinder head of a multiple cylinder engine having a plurality of intake and exhaust ports for each cylinder, in which a frictional stirring treatment is applied to at least a surface part between the intake and exhaust ports by using a predetermined rotational tool, wherein a treating path of the frictional stirring treatment corresponding to a movement locus of the rotational tool approximately along cylinder head surface is independently set for each cylinder.

According to the surface treatment method for a cylinder head mentioned above, since the treating path of the frictional stirring treatment is independently set for each cylinder, and a long treating path running through all cylinders as in a conventional method is not provided, the end hole treatment is done at one portion for each cylinder, that is, totally only at four portions, and an unnecessary treatment for a connecting portion between cylinders need not be done. As a result, the treatment time of the frictional stirring treatment can be drastically shortened, and treatment efficiency can be considerably enhanced. Also, there is no fear that dispersion among cylinders occurs regarding the treatment depth of the surface treatment.

In one embodiment of the present invention, a pattern of the treating path which is independently set for each cylinder (that is, the way of movement of the rotational tool) is substantially the same for all cylinders.

In this case, the frictional stirring treatment work can be easy and stable, compared with the case where treating path patterns differ for each cylinder so that the way of movement of the rotational tool has to be changed for each cylinder.

Further, in one embodiment of the present invention, a forward path and a backward paths are set in the treating path between the intake and exhaust ports of each cylinder. And the treatment is continuously executed for each cylinder from a treatment start portion to an end portion in the pattern of the treating path.

In this case, repeated treatments can be executed on both forward and backward paths for the surface parts of the respective space between valve ports, and thus the surface treatment can be executed effectively covering the entire width. Further more, in this case, since treatment is continuously executed for each cylinder from a start portion to an end portion in the treating path pattern, high treatment efficiency can be achieved.

Further more, in one embodiment of the present invention, the pattern of the treating path is set in such a way that the intake and exhaust ports are positioned in sides adjacent to a leading side with respect to a rotation of the rotational tool. The rotational direction corresponds to the same direction as an advancing direction of the rotational tool.

In this case, it is possible to set that a treatment region with narrow treatment area corresponds to a side of a port end with thin wall thickness. As a result, it is possible to ensure a required treatment depth and to restrain deformation of a port edge.

Further more, in one embodiment of the present invention, the forward path and backward path of the treating path between the intake and exhaust ports are set so that rotating regions of the rotational tool in the forward and backward paths are overlapped.

In this case, overlapped treatment by the forward and backward paths is executed for an approximately central region in the width direction of the space between valve ports, and thus deeper and more effective surface treatment can be executed for this region.

Further more, in one embodiment of the present invention, the multiple cylinder engine is a diesel engine having a pair of intake ports and a pair of exhaust ports for each cylinder. And the treating path is set as an approximately T-shape pattern in a plan view so as to treat respective surface parts of a region having a relatively narrow space among portions between intake and exhaust ports and a region in which a glow plug mounting hole is provided.

In this case, regarding the above-mentioned cylinder head for a diesel engine, particularly, spaces between valve ports for which improvement of mechanical characteristics including thermal fatigue strength is required can be reliably treated by the frictional stirring treatment. That is, respective surface parts of a region having a relatively narrow space among portions between intake and exhaust ports and a region in which a glow plug mounting hole is provided are reliably treated by the frictional stirring treatment.

In accordance with a second aspect of the present invention based on the first aspect of the same, there is provided a surface treatment method for a light alloy cylinder head of a multiple cylinder engine having a plurality of intake and exhaust ports for each cylinder, in which a frictional stirring treatment is applied to at least a surface part between the intake and exhaust ports by using a predetermined rotational tool, wherein the treating path being set between the intake and exhaust ports is provided with a forward path and a backward path set to be parallel to each other and a turning path connecting a end point of the forward path with a start point of the backward path. The turning path is provided with a turning point at which the travelling direction of the rotational tool is changed, and the turning point is set at a position of equal distance from each of a pair of the intake and exhaust ports adjacent to the treating path.

According to the surface treatment method for a cylinder head mentioned above, since the treating path being set between the intake and exhaust ports is provided with a forward path and a backward path set to be parallel to each other, repeated treatments can be executed on both forward and backward paths for the surface parts of the respective space between valve ports, and thus the surface treatment can be executed effectively covering the entire width. Further, since the treating path is provided with a turning path connecting a end point of the forward path with a start point of the backward path, it is possible to perform the surface treatment efficiently by moving the rotational tool from the forward path to backward path continuously. Further more, the turning path is provided with only one turning point at which the travelling direction of the rotational tool is changed from the forward path to backward path. The rotational tool is stopped to travel at the turning point, thereby the temperature of the vicinity of the turning point is raised up. However, in the present invention, there provided only one such turning point on the turning path, the temperature raising vicinity of the turning path is restrained. Further more, the turning point is set at a position of equal distance from each of a pair of the intake and exhaust ports adjacent to the treating path. That is, the turning point is located far from the edges of the intake and exhaust ports, thus the temperature raising point is also located far from the edges of the intake and exhaust ports. Accordingly, the temperature raising vicinity of the turning path is restrained, as a result, it is possible to stir sufficiently inside the treatment area and to restrain the generation of unfilled defects inside treated area vicinity of the turning path. Further more, since there provided only one such turning point on the turning path, the dispersion of temperature in the area vicinity of the turning path. Thereby, the dispersion of the treatment depth of said area (the depth of the plastic flow layer) is restrained.

As explained above, according to the surface treatment method for a cylinder head mentioned above, it is possible to restrain temperature rising in the area adjacent to the turning path, because the turning path is provided with only one turning point at which the travelling direction of the rotational tool is changed, and the turning point is set at a position of equal distance from each of a pair of the intake and exhaust ports adjacent to the treating path. As a result, it is possible to restrain deformation at the edge of the valve port, generation of unfilled defects inside the treated area and dispersion of the treatment depth.

In one embodiment of the present invention, a path between the end point of the forward path in the turning path and the turning point, and a path between the turning point and the start point of the backward path in the turning path are set to be substantially straight line paths respectively.

In this case, it is possible to restrain the generation of unfilled defects inside the treated area and dispersion of the treatment depth in the space between the intake and exhaust ports.

Further, in one embodiment of the present invention, a path between the end point of the forward path in the turning path and the turning point, and a path between the turning point and the start point of the backward path in the turning path are set to be substantially arc paths respectively.

In this case, it is possible to restrain the generation of unfilled defects inside the treated area and dispersion of the treatment depth in the space between the intake and exhaust ports.

Further more, in one embodiment of the present invention, the forward path and backward path of the treating path between the intake and exhaust ports are set so that rotating regions of the rotational tool in the forward and backward paths are overlapped.

In this case, overlapped treatment by the forward and backward paths is executed for an approximately central region in the width direction of the space between the intake and exhaust ports, and thus deeper and more effective surface treatment can be executed for this region. When the treating path between the intake and exhaust ports are set so that rotating regions of the rotational tool in the forward and backward paths are overlapped, it is fear that the temperature at the area between the intake and exhaust ports is raised up and deformation of port edges are caused as mentioned above. However, in the present invention, there provided only one such turning point on the turning path, the temperature raising vicinity of the turning path is restrained, thus deformation of port edge is restrained.

Further more, in one embodiment of the present invention, the treating path is independently set for each cylinder, and the surface treatment is continuously executed for each cylinder from a treatment start portion to an end portion in the pattern of the treating path.

In this case, the treatment time of the frictional stirring treatment can be drastically shortened, and treatment efficiency can be considerably enhanced, in comparison with the case a long treating path running through all cylinders as in a conventional method is provided. And, since treatment is continuously executed for each cylinder from a start portion to an end portion in the treating path pattern, further high treatment efficiency can be achieved.

Further more, in one embodiment of the present invention, the surface treatment method for the cylinder head further includes a preheating process in which a cast cylinder head is heated to a predetermined temperature. And the surface treatment process for the cylinder head is performed after the preheating process for the cylinder head.

In this case, by preheating the cast cylinder head, residual stress generated on the cylinder head after the surface treatment is restrained. In the case that a cylinder is subject to a surface treatment (a frictional stirring treatment) the difference of the temperature between portions softened and caused plastic flow by rotational tool in the surface treatment (plastic flow layer) and the surrounding portions thereof become to be large. Thereby thermal stress (strain) is generated on the cylinder head, and thermal fatigue strength is lowered. However, in the case that a surface treatment is conducted after a preheat treatment, since the temperature of the cylinder head is raised previously, difference of the temperature between plastic flow layer and the surrounding portions thereof is small, thereby residual stress on the cylinder head is restrained. Further, in the case that preheating is applied to the work, resistance by the cylinder head to rotational tool in the surface treatment is reduced by the preheat treatment. Thereby, required energy for frictional stirring is reduced, and generation of unfilled defects is restrained, further, bending moment applied to the tip of the rotational tool is reduced, and durability of the rotational tool 20 is improved.

Specifically, in the case that a work is subject to preheating Young's modulus of the material is lowered, accordingly a port edge is apt to cause deformation. However, in the present invention, only one turning point of a turning path is set, and the turning point is located at a position far from edge of the intake and exhaust ports adjacent to the turning point. By setting the turning path to such a shape, deformation at the port edge is restrained. Thus, it is possible to restrain generation of unfilled defects inside treated area.

In one embodiment of the present invention, the cylinder head is preferably heated at a range of 150-180 degrees centigrade in the preheating process.

In this case, the lower limit of the preheating temperature set to 150 degrees centigrade is due to fact that, although the residual stress of the cylinder head is reduced, the dispersion of the residual stress is possibly larger, when the heating is lower than 150 degrees centigrade. On the other hand, the higher limit of the preheating temperature set to 180 degrees centigrade in this case is due to fact that the cylinder head is softened by over aging when preheating temperature is higher than 180 degrees centigrade.

In accordance with a third aspect of the present invention, there is provided a light alloy cylinder head of a multiple cylinder engine having a plurality of intake and exhaust ports for each cylinder wherein surface treatment by a frictional stirring treatment is applied to at least a surface part between the intake and exhaust ports by using a predetermined rotational tool. The surface treatment part is formed independently for each cylinder in accordance with a treating path of the frictional stirring treatment corresponding to a movement locus of the rotational tool approximately along cylinder head surface.

According to the cylinder head mentioned above, since a surface treatment part independent for each cylinder is formed according to the treating path of the frictional stirring treatment, and since surface treatment along a long treating path running through all cylinders as in a conventional method is not executed, unnecessary surface treatment for a connecting region between cylinders need not be done, the end hole treatment is done at one portion for each cylinder, that, is, totally at four portions, treatment efficiency of the frictional stirring treatment is high, and dispersion of the treatment depth of surface treatment between cylinders is restrained.

In one embodiment of the present invention, the multiple cylinder engine is a diesel engine having a pair of intake ports and a pair of exhaust ports for each cylinder. And the surface treatment part thereof is formed as an approximately T-shape pattern in a plan view by a treatment region having a relatively narrow space among portions between intake and exhaust ports and a treatment region in which a glow plug mounting hole is provided.

In this case, in a cylinder head for a diesel engine having a pair of intake ports and a pair of exhaust ports for each cylinder, particularly, space between valve ports for which improvement of mechanical characteristics including thermal fatigue strength is required are reliably treated by the frictional stirring treatment That is, respective surface parts of a region having a relatively narrow space among portions between intake and exhaust ports and a region in which a glow plug mounting hole is provided are reliably treated by the frictional stirring treatment to give a cylinder head whose mechanical characteristic is improved.

In accordance with a fourth aspect of the present invention, there is provided a light alloy cylinder head of a diesel engine which is provided with a cylinder having a pair of intake ports and a pair of exhaust ports and in which surface treatment by a frictional stirring treatment is applied to at least a surface part between the intake and exhaust ports by using a predetermined rotational tool. A surface treatment part is formed as an approximately T-shape pattern in a plan view by a treatment region having a relatively narrow space among portions between intake and exhaust ports and a treatment region in which a glow plug mounting hole is provided.

According to the cylinder head mentioned above, in a light alloy cylinder head of a diesel engine provided with a cylinder having a pair of intake ports and a pair of exhaust ports, particularly, space between valve ports for which improvement of mechanical characteristics including thermal fatigue strength is required are reliably treated by the frictional stirring treatment. That is, respective surface parts of a region having a relatively narrow space among portions between intake and exhaust ports and a region in which a glow plug mounting hole is provided are reliably treated by the frictional stirring treatment to give a cylinder head whose mechanical characteristic is improved.

### BRIEF DESCRIPTION OF THE DRAWINGS

FIG. 1 is a perspective view schematically illustrating a surface treatment subject member and main portions of a frictional stirring treatment apparatus for explaining a surface treatment method by a frictional stirring treatment according to an embodiment of the present invention;

FIG. 2 is a cross-sectional explanatory view schematically illustrating the surface treatment subject member and the main portions of the frictional stirring treatment apparatus;

FIG. 3 is an enlarged front view of an end portion of a rotational tool illustrating a modified example of a probe portion of the rotational tool;

FIG. 4 is an enlarged front view of an end portion of a rotational tool illustrating another modified example of a probe portion of the rotational tool;

FIG. 5 is a plan explanatory view schematically illustrating a mating face with a cylinder block of a casting member for a cylinder head according to a first embodiment of the present invention;

FIG. 6 is a plan explanatory view illustrating enlarged one of cylinder parts of the cylinder head;

FIG. 7 is a cross-sectional explanatory view of a space between valve ports taken along Y7-Y7 line of FIG. 6;

FIG. 8 is an explanatory view schematically illustrating the relationship between a combination of the advancing direction and the rotating direction of a rotational tool and a cross section of a treated region of a work;

FIG. 9 is an explanatory view schematically illustrating a cross section of a treated region of a work according to one example of a combination pattern of the advancing direction and the rotation direction of the rotational tool;

FIG. 10 is an explanatory view schematically illustrating a cross section of a treated region of a work according to another example of a combination pattern of the advancing direction and the rotation direction of the rotational tool;

FIG. 11 is an explanatory view schematically illustrating a cross section of a space between valve ports of a comparative example in applying the frictional stirring treatment to a port end of the space between valve ports of a cylinder head;

FIG. 12 is an explanatory view schematically illustrating a cross section of a space between valve ports in a case where the frictional stirring treatment is applied to a port end of a space between valve ports of a cylinder head according to the present invention;

FIG. 13 is a plan explanatory view schematically illustrating a mating face with a cylinder block of a casting member for a cylinder head according to a second embodiment of the present invention;

FIG. 14 is a plan explanatory view schematically illustrating a mating face with a cylinder block of a casting member for a cylinder head according to a third embodiment of the present invention;

FIG. 15 is a plan explanatory view schematically illustrating a mating face with a cylinder block of a casting member for a cylinder head according to Comparative Example 1;

FIG. 16 is a plan explanatory view schematically illustrating a mating face with a cylinder block of a casting member for a cylinder head according to Comparative Example 2;

FIG. 17 is a front view of a rotational tool employed to conduct a surface treatment according to the fourth embodiment of the present invention;

FIG. 18 is a flow chart describing a process of a surface treatment for a cylinder head according to the fourth embodiment of the present invention;

FIG. 19 is a plan explanatory view schematically illustrating a mating face with a cylinder block of a casting member for a cylinder head according to the fourth embodiment of the present invention;

FIG. 20 is a plan explanatory view illustrating enlarged one of cylinder parts of the cylinder head according the fourth embodiment;

FIG. 21 is a graph illustrating a measurement result of residual stress on the cylinder head according the fourth embodiment;

FIG. 22 is a plan explanatory view schematically illustrating a mating face for a cylinder block of a casting member for a cylinder head CH7 according to Comparative Example;

FIG. 23 is a graph illustrating a measurement result of occurrence ratio of unfilled defects in comparative test;

FIG. 24 is a graph illustrating a measurement result of depth of refined layer in comparative test;

FIG. 25 is a plan explanatory view illustrating enlarged one of cylinder parts of the cylinder head according the fifth embodiment.

### DETAILED DESCRIPTION OF THE PREFERRED EMBODIMENT

Embodiments of the present invention will be explained in detail below, referring to accompanying drawings.

Prior to the explanation of cylinder heads and their surface treatment methods according to the embodiments of the present invention, first, the frictional stirring treatment method is explained. It is the basic technique of the surface treatment method according to the embodiment.

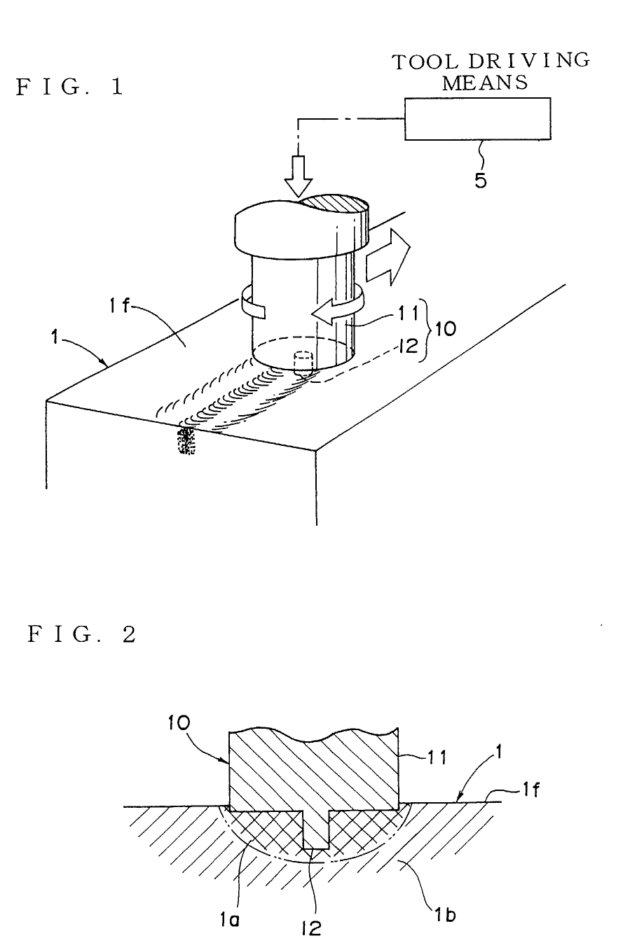

FIGS. 1 and 2 are a perspective view and a cross-sectional explanatory view schematically illustrating a surface treatment subject member and main portions of a frictional stirring treatment apparatus for explaining surface treatment by the frictional stirring treatment. As shown in these figures, in a surface treatment method according to the present embodiment, a light metal member 1 which is the treatment subject of surface treatment is placed on a base member (not shown) and fixed thereto. And, thereafter, a surface treatment is conducted by contacting a rotational tool 10 with a surface 1f of the light metal member 1 and intruding it the surface part 1f of the light metal member 1.

The rotational tool 10 is constituted by a rotational base portion 11 of a column with a predetermined diameter and a probe portion 12 of a column which is integrally fixed on a central portion of an end of the base portion 11 and which has a predetermined length and a relatively small diameter (smaller than that of the rotational base portion 11). The rotational base portion 11 is rotatably supported about the axis thereof by means of a holder which is not shown, and this holder (not shown) is rotatably driven by a tool driving means 5 so that the rotational tool 10 is rotated about the axis.

The tool driving means 5, although being not shown specifically, is provided with a drive motor for rotating the rotational tool 10 at high speeds via the holder (not shown). The tool driving means 5 is also provided with a drive mechanism for driving the rotational tool 10 in a direction approximately perpendicular to the surface 1f of the light metal member 1 (that is, a vertical direction in FIGS. 1 and 2) and for moving the rotational tool 10 approximately along the member surface 1f.

By driving the driving means 5, the bottom portion of the rotational tool 10 in a high speed rotating state can be intruded into the surface part of the light metal member 1 in the direction approximately perpendicular to the surface 1f of the light metal member 1 (that is, the depth direction of the member 1), and can be moved approximately along the member surface 1f.

Such mechanism to drive a rotating body (rotational tool 10) in the direction approximately perpendicular to the member surface 1f (approximately vertical direction) and to move it along the member surface 1f (approximately horizontal direction) is conventional one and well known for example as a feed screw mechanism, a robot arm, and the like. Thus, detailed explanation and drawings regarding the construction of the mechanism are omitted. Instead of driving the rotational tool 10 in an approximately vertical direction and move it in an approximately horizontal direction, the base member (not shown) on which the treatment subject member 1 is fixed may be driven so as to perform relative movement with respect to the rotational tool 10.

Further, the rotating body 10 is not limited to one which is provided with the small diameter probe portion 12 on an end portion (lower end portion) of the rotational base portion 11 as shown in FIGS. 1 and 2. A rotating body having no probe portion 12 and whose underside is flat may also be employed. These two types of rotating body may be alternatively used in accordance with required depth of the surface treatment. In the case where a certain level of depth is required, a type of rotating body 10 having the probe portion 12 may be employed. And, in the case where it is not necessary to execute a very deep treatment, a type of rotating body having no probe portion 12 may be employed. Thereby, the surface treatment can be implemented efficiently.

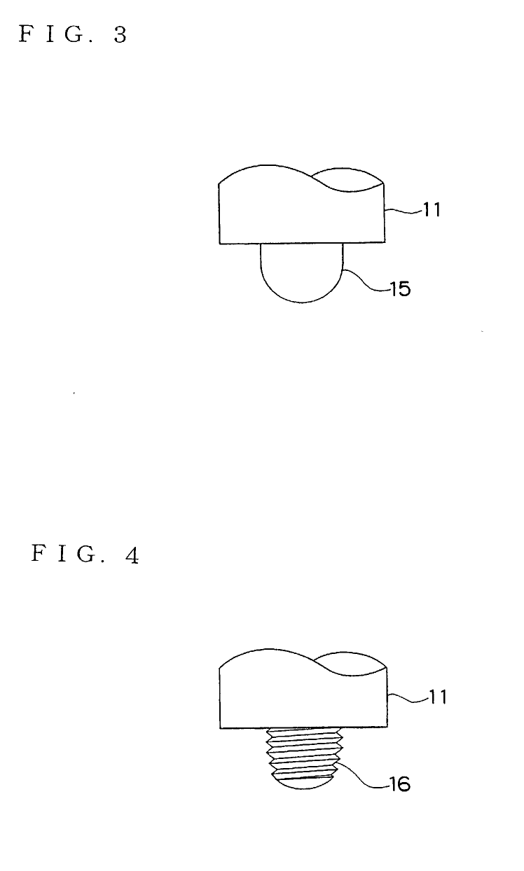

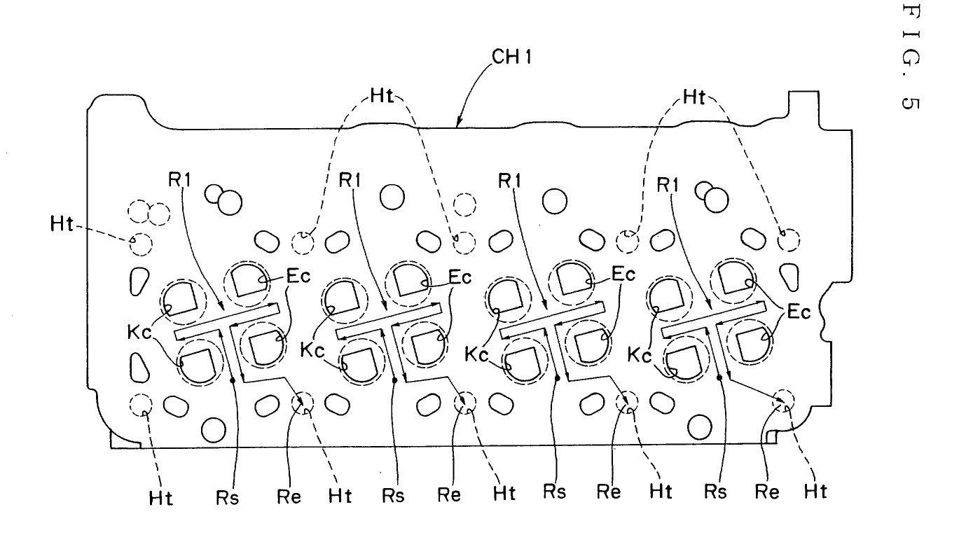

Further, the probe portion 12 disposed on the end of the rotational base portion 11 is not limited to the column-shaped-one shown in FIGS. 1 and 2, and various features of the probe portion can be employed. For example, a probe portion 15 whose end portion is shaped into a curved surface such as a hemisphere as shown in FIG. 3, a probe portion 16 whose outer periphery is given screw thread cutting of an external screw as shown in FIG. 4, or the like can be employed.

In the surface treatment method by the frictional stirring treatment according to the present embodiment, while the bottom portion of the rotational tool 10 (that is, the undersides of the probe portion 12 and the rotational base portion 11) rotating at high speeds is caused to abut and press the surface 1f of the light metal member 1, the rotational tool 10 is caused to intrude into the member surface part 1f until the tool reaches a predetermined depth in the depth direction of the light metal member 1 (refer to FIG. 2).

By frictional heat generated at that time and stirring effect of the rotational tool 10, the portion of the member surface 1f abutting the rotational tool and the vicinity thereof are softened so that a plastic flow is allowed to occur. The material of this plastic state (plastic flow layer 1a) is stirred in a non-melting condition, and then the plastic flow layer 1a is cooled. Thereby, the surface part of this member and the vicinity thereof are refined, and fine metal structure with a high hardness compared with a surrounding base material 1b can be obtained.

In the case that the surface refining treatment by the frictional stirring treatment is applied to the surface of a casting member made of a light metal such as for example an aluminum alloy, the metal structure of the surface part of the casting member becomes finer, and internal unfilled defects due to blowhole or the like can be drastically reduced, in comparison with a case by the so-called remelt treatment and the like in which a surface part is melted to refine the surface part. Thereby, mechanical characteristics such as elongation, toughness, and the like and fatigue strength (thermal fatigue strength) can be improved. In this case, there is no risk that blowhole or pin hole due to a gas or the like inside the casting member is formed as in the case where a surface part is melted by the remelt treatment or the like to refine the surface part.

In the case that the surface treatment by the frictional stirring treatment is applied to the surface part of the light metal member 1, when the axis of the rotational tool 10 is maintained completely vertically with respect to the member surface 1f to move the tool 10, in some cases unfilled defects occurs in the treated member corresponding to a part near corner portions of the probe portion 12 depending on the size and shape of the probe portion 12. In order to prevent such defects from occurring, it is preferred that the rotational tool 10 is moved approximately along the member surface 1f while the posture of the rotational tool 10 is maintained so that the axis thereof tilts a little (e.g., the tilt angle is about 5 degrees or less) from a complete vertical state (tilt angle is 0 degree). In this case, it is further preferable in terms of the improvement of productivity that the rotational tool 10 is tilted so that the front side of the underside of the base portion 11 of the rotational tool 10 in the forward direction of the rotational tool is lifted compared with the rear side.

Next, a cylinder head and the surface treatment method therefor according to a first embodiment of the present invention are explained.

FIG. 5 is a plan explanatory view schematically illustrating a mating face with a cylinder block (not shown) of a cylinder head casting member according to the first embodiment. As shown in this drawing, the cylinder head CH1 is for a diesel engine of in-line type having four cylinders, and a pair of intake ports Kc and a pair of exhaust ports Ec are provided for each cylinder that are disposed forming a line along the longitudinal direction thereof. The member surface area between ports (that is, the space between valve ports) in each cylinder is approximately cross-shaped.

This cylinder head CH1 is manufactured by casting process using for example an aluminum alloy as a material, and the surface treatment by the above-described frictional stirring treatment method is to be applied specifically to space between valve ports of the mating face with a cylinder block (not shown).

As a light alloy material for the cylinder head CH1, for example, aluminum alloy AC4D prescribed in JIS (Japanese Industrial Standard) is employed. Instead of this, AC4B, or AC2B, or AC8A or the like can be employed.

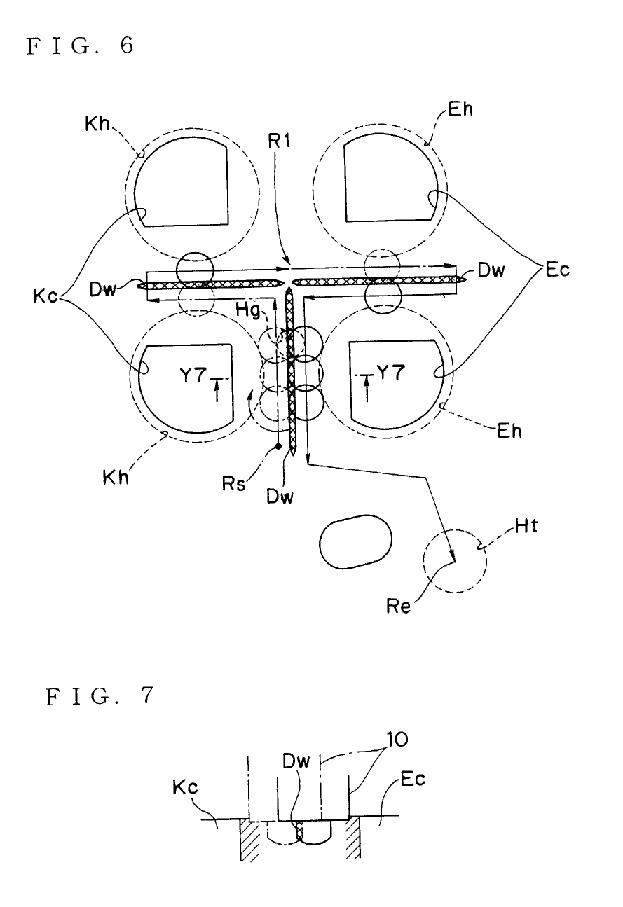

Prior to the surface treatment, the mating face with the cylinder block of the cylinder head is roughly machined by milling in the pre-process. FIG. 5 shows the mating face in a finished state by the rough machining. That is, all of the above-mentioned respective intake ports Kc and exhaust ports Ec shown by solid lines in FIG. 5 indicate casting holes. However, actually, as shown enlarged in FIG. 6, the ports are finished through machining process such as drilling after the surface treatment for the space between valve ports. Thereby, finished intake ports Kh and exhaust ports Eh which have a predetermined shape, size, and surface roughness (refer to the broken line expression in FIGS. 5 and 6) are obtained.

A plurality of holes Ht for tension bolts arranged along the longitudinal direction are drilled in the cylinder head CH1 by drilling after the surface treatment. These tension bolt holes Ht are to be used for inserting tension bolts for fastening and fixing therein, when the cylinder head CH1 is assembled in the cylinder block to be fastened and fixed after finishing process is completed. The tension bolt holes Ht are provided along a pair of parallel straight lines so as to sandwich four cylinder portions arranged in the longitudinal direction. Also, these tension bolt holes Ht are disposed at five positions for each row, and their positions are set near both ends of the cylinder head in the longitudinal direction and at portions between the respective cylinder parts.

It is to be noted that, in FIG. 5, hole portions shown by curved solid lines indicate the so-called casting holes which are formed in casting process. On the other hand, all hole portions shown by curved broken lines in the same drawing are not hole portions in a casting state, but they are to be formed as holes by finishing into a predetermined shape, size, and surface roughness through machining process such as drilling and the like after the surface treatment for space between valve ports and the like is implemented.

In the present embodiment, the surface treatment by the above-described frictional stirring treatment method is applied to at least the surface part between intake and exhaust ports (space between valve ports) in the cylinder head CH1. However, a treating path R1 of the frictional stirring treatment is independently set for each cylinder, and a long treating path running through all cylinders as in the prior art method is not provided.

The patterns of the respective treating paths R1 each of which is independently set for each cylinder are substantially the same for all cylinders.

This treating path R1 corresponds to the locus of the rotational tool's movement approximately along the cylinder head surface. The rotational tool 10 is employed in the frictional stirring treatment. As shown in detail in FIG. 6, the treating path R1 is set as an approximately T-shape pattern in plane view (refer to straight lines to which arrows are affixed in FIG. 6). The treating path R1 is set so as to treat the respective surface parts including the space between valve ports that is between the intake ports Kc, the space between valve ports that is between the exhaust ports Ec whose widths are relatively narrow, and an area which is a space between valve ports that is between an intake port Kc and an exhaust port Ec and that is of the side in which a glow plug mounting hole Hg is provided, among space between valve ports which are approximately cross-shaped as a whole.

The glow plug mounting hole Hg is formed through machining process such as drilling after the surface treatment for the space between valve ports and is provided for each cylinder.

In the present embodiment, both widths of the space between valve ports that is between intake ports Kc and the space between valve ports that is between exhaust ports Ec are set to about 10.0 mm, and the width of the space between valve ports that is between an intake port Kc and an exhaust port Ec is set to about 11.3 mm.

Specifically, the space between valve ports that is between exhaust ports Ec is exposed to a high temperature (compared with the intake port Kc side) when the engine is driven, and the width thereof is narrow. Therefore, it is necessary to execute surface treatment to enhance mechanical characteristics such as thermal fatigue strength and the like. With respect to the space between valve ports that is between an intake port Kc and an exhaust port Ec and that is of the side in which the glow plug mounting hole Hg is provided, the width of the space between valve ports of the side in which the glow plug mounting hole Hg is provided becomes considerably narrow and the area of that space between valve ports becomes small. Therefore, it is necessary to execute surface treatment to improve mechanical characteristics after all.

As shown by line segments with arrows in FIG. 6, forward and backward paths are set in the treating path R1 among the intake and exhaust ports (space between valve ports) of each cylinder. Specifically, the forward and backward paths of the treating path R1 of said space between valve ports are set in such a way that at least part of the rotating region of the rotational tool 10 overlaps as clearly seen in FIG. 7 (overlap region: Dw). Treatment is performed continuously from a treatment start portion Rs to a treatment end portion Re for each cylinder in the pattern of the treating path R1.

It is to be noted that, in FIG. 6, the forward path is indicated by line segments of dashed lines with arrows, and the backward path is indicated by line segments of solid lines with arrows. Also, small circles drawn on the treating path R1 virtually show a feature of the movement of the probe portion of the rotational tool 10.

When the frictional stirring treatment for each cylinder is executed, the position of the rotational tool 10 is first set at the treatment start portion Rs and is advanced along dashed lines with the start of the treatment. That is, at first, the space between valve ports that is between an intake port Kc and an exhaust port Ec and that is of the side in which the glow plug mounting hole Hg is provided is treated (treatment of the forward path). Then, a 90 degrees direction change is made to treat the space between valve ports that is between the intake ports Kc. Next, the rotational tool 10 makes a turn at the trailing end portion of the space between valve ports that is between the intake ports Kc. And thereafter, the tool treats the space between valve ports that is between the intake ports Kc along the solid lines once again (treatment of the backward path).

Further, the tool enters the space between valve ports that is between the exhaust ports Ec to treat this space between valve ports along the dashed lines (treatment of the forward path) to make a turn at the trailing end portion thereof. The tool is advanced along the solid lines to treat the space between valve ports that is between the exhaust ports Ec once again (treatment of the backward path). Then, the tool makes a 90 degrees direction change to treat the space between valve ports that is between an intake port Kc and an exhaust port Ec and that is of the side in which the glow plug mounting hole Hg is provided once again (treatment of the backward path).

After finishing the surface treatment for the space between valve ports, the rotational tool 10 is moved up to the processing end portion Re in the pattern of the treating path R1 as an end hole treatment, and the rotation of the tool 10 is stopped at the end portion Re so that the tool 10 is lifted upward. This end portion Re of the surface treatment is set so as to correspond to approximately the center of a drilling portion of the tension bolt-hole Ht whose position is set near the cylinder portion.

Since this portion is drilled by machining process to be removed after the surface treatment for the space between valve ports as described above, even after the end hole treatment of the frictional stirring treatment is executed, the end hole does not remain in a final product.

Although not being specifically illustrated, the tool driving means 5 of the rotational tool 10 is preferably connected to a controller with a control unit which is for example constructed including a microcomputer as a principal part so that a signal can be transmitted and received to each other. And setting of the treatment depth with respect to a work (treatment subject member) surface part, a movement locus on a work surface, and the like are automatically set in accordance with a command signal from the controller based on a predetermined control program.

As described above, in the present embodiment, the treating path R1 of the frictional stirring treatment is independently set for each cylinder, and a long treating path running through all cylinders as in the prior art method is not provided. Therefore, the end hole treatment is only done at one portion for each cylinder, that is, totally at four portions, and also, unnecessary treatment for a region located between cylinders need not be done. As a result, the treatment time of the frictional stirring treatment can be drastically shortened, and treatment efficiency can be considerably enhanced. There is no fear that dispersion among cylinders occurs regarding the treatment depth of the surface treatment.

Specifically, in the present embodiment, the respective pattern of the treating path R1 which is independently set for each cylinder (that is, the way of movement of the rotational tool 10) is set so as to be substantially the same for all cylinders. Thereby, the frictional stirring treatment work can be easy and stable, compared with the case where treating path patterns differ for each cylinder so that the way of movement of the rotational tool 10 has to be changed for each cylinder.

Further, in the present embodiment, the forward and backward paths are set in the treating path R1 of the space between valve ports of each cylinder. Therefore, repeated treatment is executed on both forward and backward paths for the surface parts of the respective space between valve ports, and thus the surface treatment can be executed effectively covering the entire width thereof. In this case, since treatment is continuously executed from the start portion Rs to the end portion Re in the treating path pattern R1 for each cylinder, a high treatment efficiency can be maintained.

Specifically, in the present embodiment, the forward and backward paths of the treating path R1 of the space between valve ports are set in such a way that at least a part of the rotating region of the rotational tool 10 overlaps (overlap region: Dw). Therefore, an overlapped treatment by the forward and backward paths is executed for an approximately central region in the width direction of the space between valve ports, and thus deeper and more effective surface treatment can be executed for the region Dw.

Further more, in the present embodiment, as clearly seen in FIG. 6, the pattern of the treating path R1 is set in such a way that the intake and exhaust ports Kc, Ec are positioned in sides adjacent to a leading side with respect to a rotation of the rotational tool 10 which correspond to the same direction as an advancing direction of the rotational tool 10 when the frictional stirring treatment is executed along the treating path R1.

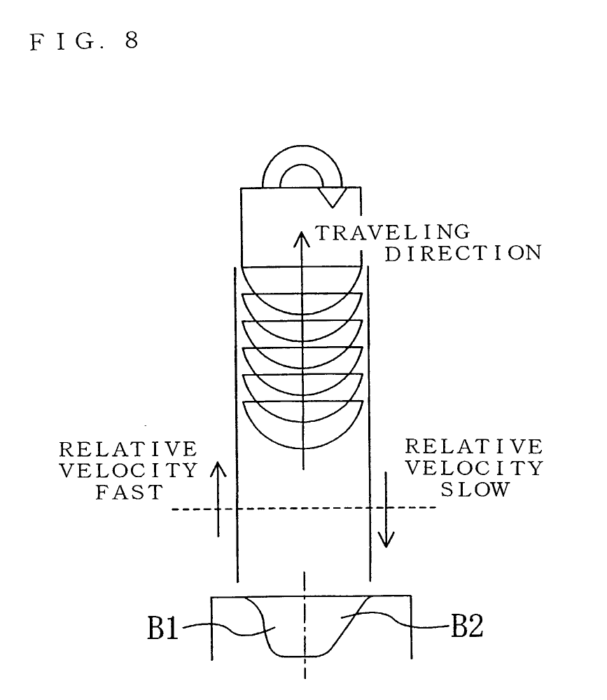

That is, as schematically shown in FIG. 8, for example, in the case that the rotational tool is rotated in a clockwise direction (right-handed direction in the drawing) about a center axis in the view of a plan, in the left side seen from the traveling direction of the rotational tool, the direction of the surface speed of the rotation and the direction of the tool travel speed are in the same direction. Therefore, the relative speed between the rotational tool and the work (treatment subject member) surface part becomes greater. On the other hand, in the right side seen from the travel direction of the rotational tool, since the surface speed of the rotation and the tool travel speed are in the opposite directions, the relative speed between the rotational tool and the work surface part becomes smaller.

In such case, when a cross-section of the work treatment region by the rotational tool is seen, the plastic flow at the same position with respect to the width direction becomes deeper (treatment region: B1) although the treatment region is small in the side where the relative speed becomes greater (the left side seen from the travel direction in the drawing). While the plastic flow at the same position with respect to the width direction becomes shallower (treatment region: B2) although the treatment region is large in the side where the relative speed becomes smaller (the right side seen from the travel direction in the drawing). It can be considered that this difference between the two parties B1, B2 is caused by the fact that a work base material is stirred fast and narrowly when the relative speed is great and is stirred relatively slowly in a wide range when the relative speed is small.

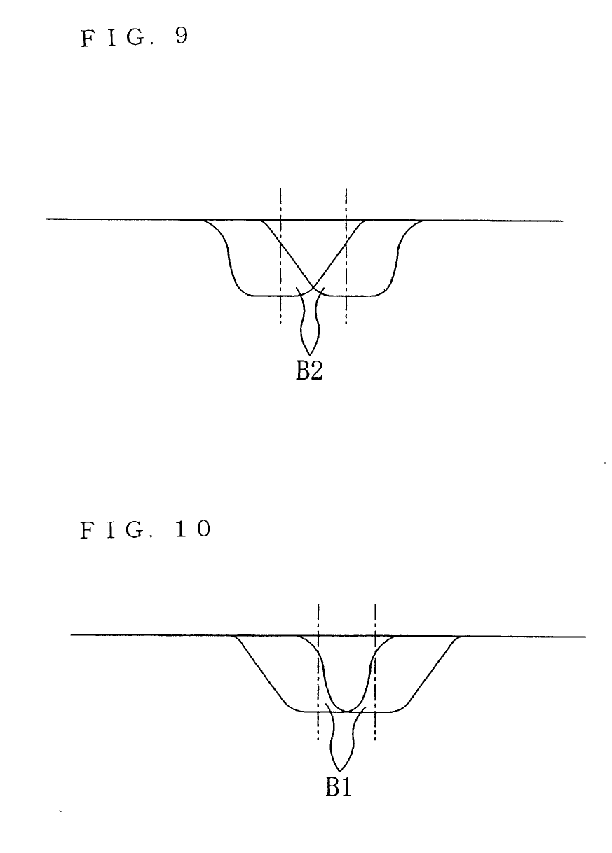

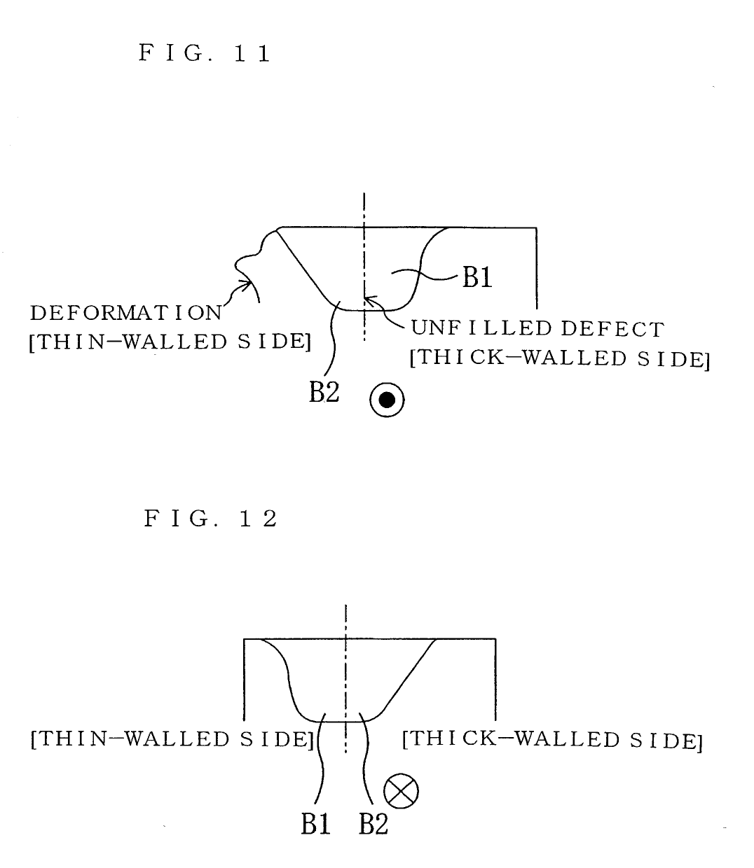

By utilizing the characteristics above, when the rotating regions of the rotational tool of the forward and backward paths are overlapped, as shown in FIG. 9, setting can be done in such a way that two regions B2 with large treatment areas are overlapped so that the treatment depth becomes as uniform as possible. Conversely, as shown in FIG. 10, setting can be done in such a way that two regions B1 with narrow treatment areas (plastic flow is deep) are overlapped so that the treatment depth is curbed to restrain the outflow of a material.

When the space between valve ports of the cylinder head CH1 are treated by the frictional stirring treatment, although it is desired that the treatment is applied to a portion as near a port end as possible. However, when it is set that the region B2 having large treatment area is positioned at a thin-walled side of a port end as schematically shown in FIG. 11, for example, there is a fear that deformation occurs in a shoulder portion of the port end and the vicinity thereof and thereby causing unfilled defects inside a treatment region.

Thus, in the present embodiment, by setting the pattern of the treating path R1 in such a way that the intake and exhaust ports Kc, Ec are positioned in sides adjacent to a leading side with respect to the rotation of the rotational tool 10 which correspond to the same directions as the advancing directions of the rotational tool 10, that is, by setting in such a way that a neighboring port is always positioned in the left side in the case where the rotation direction of the tool 10 is clockwise, the region B1 having small treatment area is caused to exist in a thin-walled side of the port end as schematically shown in FIG. 12, whereby a required treatment depth is ensured, and deformation of a port end is restrained.

The difference in the treatment areas and the plastic flow depths due to the combination of the travel direction and the rotation direction of the rotational tool 10 is exhibited very remarkably in the case where the probe portion of the rotational tool 10 is of a type in which thread grooves of an external thread are provided on the outer periphery for example as shown in FIG. 4. That is, for example in the case where the thread grooves of the probe portion 16 are of a left-handed screw and the rotational tool 10 is rotated in a clockwise direction, that is, in the case where a threading direction of the thread grooves and the tool rotation direction are opposite, a work material is stirred about the probe portion 16 while being pressed against the inside, whereby the difference in characteristics is markedly exhibited.

Even in the case where the shape of the probe portion is of a column type (refer to FIGS. 1 and 2) or of a hemispheric type (refer to FIG. 3), a similar tendency regarding the difference in characteristics can be obtained in greater or lesser degrees.

Implemented was comparative examination for comparing a surface treatment method for a space between valve ports of a cylinder head CH1 according to the present embodiment and a surface treatment method for a space between valve ports of a cylinder head according to a comparative example in which a long treating path extending in the longitudinal direction of the cylinder head, running through all cylinders, is provided. Next, this comparative examination is explained.

In the explanation below, the same numerals are affixed to those having structures and functions similar to those in the case of the cylinder head CH1 according to the first embodiment, and further explanation is omitted.

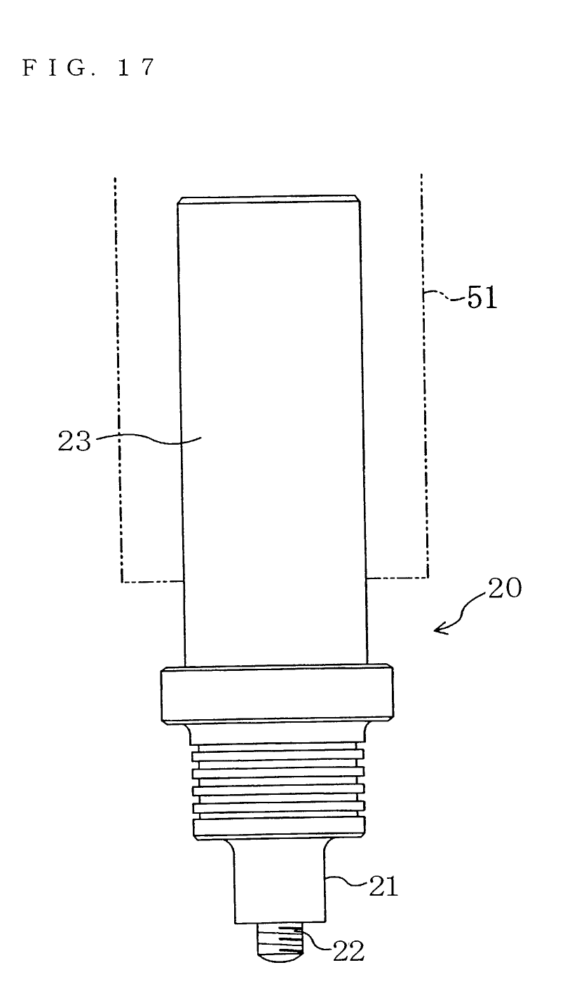

FIG. 15 is a plan explanatory view schematically illustrating a mating face for a cylinder block of a casting material for a cylinder head CH4 according to Comparative Example 1. As shown in this drawing, in the cylinder head CH4 of this Comparative Example 1, surface treating paths for space between valve ports by the frictional stirring treatment are composed of totally five treating paths. That is, a long treating path L4 extending in the longitudinal direction of the cylinder head CH4, running through all cylinders, is provided in addition to relatively short treating paths R4 which are provided for the cylinders, respectively, extending approximately in the width direction of the cylinder head CH4. The surface treatment for the space between valve ports of the intake and exhaust ports of the four cylinders is to be performed along those treating paths through a series of processes.

In the long treating path L4 of the longitudinal direction, treatment is executed sequentially from a treatment start portion Ls adjacent to one end side of the cylinder head CH4 in the longitudinal direction (left end side in FIG. 15) to the space between valve ports that are between the intake ports Kc of the respective cylinders and the space between valve ports that are between the exhaust ports Ec (treatment of the forward path), a turn is made close to the end of the opposite side so that the treatment of the backward path is executed, and an end hole treatment is executed at a treatment end portion Le.

That is, in this Comparative Example 1, in addition to the end hole treatments in the respective treating paths R4 for the respective cylinders, the end hole treatment for the long treating path L4 of the longitudinal direction has to be executed. Further, in the surface treatment along this long treating path L4, the treatment is executed not only for the space between valve ports but also for the connecting portion between cylinders with the movement of the rotational tool 10.

In this comparative examination, in order to clarify treatment efficiency (that is, treatment time) and difference in treatment results due to the difference of the treating paths, the surface treatment for the space between valve ports of both cylinder heads CH1, CH4 was executed, employing the same treatment apparatus including the rotational tool 10, the shape of the probe portion, and the like under the same frictional stirring treatment conditions. Also, in this comparative examination, a type of the probe portion 16 shown in FIG. 4 is employed. That is, thread grooves of an external thread are provided on the outer periphery of the prove portion as shown in FIG. 4. The treatment was executed while setting was done in such a way that the probe portion 16 of the thread grooves of a left-handed screw is rotated in a clockwise direction.

Sixty direct injection diesel engine cylinder head casting members of the in-line type with a series four cylinder were prepared as test products. They were manufactured using the same material and specifications, and the spaces between valve ports thereof were machined roughly before the surface treatment. With respect to thirty members of them, the surface treatment was conducted along the treating path R1 shown in FIG. 5, as the present embodiment. And, with respect to remaining thirty members, the surface treatment was conducted along the treating paths R4 and L4 shown in FIG. 15, as the comparative example Thereafter, required time for the treatment for one unit, a mean value and a dispersion of the treatment depths, and the like were compared.

Each of the test products (30 pieces) of the embodiment according to the present invention and the test products (30 pieces) of the comparative example were respectively given with sequence numbers of Nos. 1 to 30 in order of execution of the frictional stirring treatment. And, the surface treatment by the frictional stirring treatment for the space between valve ports of the respective test products was executed for each group of the test products of the embodiment according to the present invention and those of the comparative example.

As a result of the comparative examination, the mean value of the time required for the treatment for one member is a little longer than four minutes regarding the comparative examples and a little shorter than three minutes regarding the examples of the present embodiment. That is, by adopting the treatment method of the present invention, it was found that the treatment time can be shortened 25% or more compared with the treatment method of the comparative example.

This is because the number of end hole treatments in the treating path of the present embodiment can be one time less than that in the treating path of the comparative example and because the treatment for the region located between cylinders is unnecessary in the treating path of the present embodiment.

With respect to the respective test products after the completion of the surface treatment, the depths of the frictional stirring treatment (the depth of a refined layer) of the respective space between valve ports were examined and were compared for each respective cylinder. The examination of the treatment depth was a sampling examination wherein four of thirty test products of the present embodiment and four of thirty test products of the comparative example were sampled. In this sampling examination, regarding the respective test products of the present embodiment and comparative example, sampling pieces were determined based on the sequence numbers of Nos. 1 to 30 which are affixed in order of execution of the frictional stirring treatment for the space between valve ports. That is, the respective No. 1 pieces (ones at start of the surface treatments for each group) were sampled as respective Samples S1, the respective No. 10 pieces were sampled as respective Samples S2, the respective No. 20 pieces were sampled as respective Samples S3, the respective No. 30 pieces (ones of completion of the surface treatments for each group) were sampled as respective Samples S4.

The treated surfaces of the respective samples for which the surface treatment has been completed were machined by milling for about 2 mm. Thereafter, the treated portions by the frictional stirring treatment were cut, and the cut surfaces were polished to measure the depth of the refined layer. The measurement was conducted by employing a profile projector at a magnification of 20. Measured data is shown in Table 1. Microscopic observation for the polished cut surface was executed with a magnification of 50, employing a metallurgical microscope, and internal unfilled defects were not recognized in both present invention embodiment and comparative example.

TABLE 1

| | | COMPARATIVE | | | | | |
|---|---|---|---|---|---|---|---|
| | | EXAMPLE | | | EMBODIMENT | | |
| | | IN- | EX- | IN- | IN- | EX- | IN- |
| | | IN | EX | EX | IN | EX | EX |
| SAMPLE S1 | FIRST | 3.87 | 4.08 | 3.74 | 4.02 | 3.85 | 3.69 |
| (No. 1) | CYLINDER | | | | | | |
| | SECOND | 3.90 | 4.09 | 3.87 | 3.94 | 3.88 | 3.69 |
| | CYLINDER | | | | | | |
| | THIRD | 4.02 | 4.00 | 3.82 | 3.71 | 3.91 | 3.73 |
| | CYLINDER | | | | | | |
| | FOURTH | 3.79 | 3.86 | 3.77 | 3.61 | 3.88 | 3.60 |
| | CYLINDER | | | | | | |
| SAMPLE S2 | FIRST | 3.59 | 3.90 | 3.76 | 4.14 | 4.02 | 3.77 |
| (No. 10) | CYLINDER | | | | | | |
| | SECOND | 3.73 | 3.83 | 3.83 | 4.23 | 4.08 | 3.97 |
| | CYLINDER | | | | | | |
| | THIRD | 3.68 | 3.90 | 4.04 | 3.83 | 4.06 | 3.99 |
| | CYLINDER | | | | | | |
| | FOURTH | 3.55 | 3.69 | 3.78 | 3.72 | 3.88 | 4.06 |
| | CYLINDER | | | | | | |
| SAMPLE S3 | FIRST | 3.51 | 3.69 | 3.75 | 4.04 | 3.97 | 3.84 |
| (No. 20) | CYLINDER | | | | | | |
| | SECOND | 3.53 | 3.83 | 3.81 | 4.09 | 3.96 | 3.88 |
| | CYLINDER | | | | | | |
| | THIRD | 3.52 | 3.81 | 3.79 | 3.91 | 3.95 | 3.96 |
| | CYLINDER | | | | | | |
| | FOURTH | 3.40 | 3.66 | 3.66 | 3.76 | 3.95 | 3.79 |
| | CYLINDER | | | | | | |
| SAMPLE S4 | FIRST | 3.81 | 4.04 | 3.83 | 4.19 | 3.96 | 3.86 |
| (No. 30) | CYLINDER | | | | | | |
| | SECOND | 3.93 | 4.07 | 3.92 | 4.00 | 4.01 | 4.00 |
| | CYLINDER | | | | | | |
| | THIRD | 3.82 | 4.07 | 3.93 | 4.03 | 4.01 | 3.95 |
| | CYLINDER | | | | | | |
| | FOURTH | 3.68 | 3.70 | 3.85 | 3.88 | 3.98 | 3.83 |
| | CYLINDER | | | | | | |

| | | |
|---|---|---|
| MEAN VALUE | 3.806 | 3.917 |
| DEVIATION | 0.162 | 0.141 |

In Table 1, “IN-IN” denotes a space between valve ports that is between intake ports, “EX-EX” denotes a space between valve ports that is between exhaust ports, and “IN-EX” denotes a space between valve ports that is between an intake port and an exhaust port, respectively. First cylinder to fourth cylinder in Table 1 depicts an arrangement order of the cylinder portions regarding the respective sampled cylinder heads. Respective ones in a right end are first cylinders, and second, third, and fourth cylinders are designated in order of their arrangement toward the left side in FIG. 5 (the embodiment of the present invention) and FIG. 15 (comparative example). Accordingly, in the comparative example, the long treating path L4 running through all cylinders starts the forward path treatment from the fourth cylinder and makes a turn after finishing the forward path treatment for the first cylinder.

As understood from the measured data of Table 1, by adopting the treatment method of the present invention, the depth of the refined layer was deepened approximately 0.11 mm (about 3%) on average, and the dispersion was to be reduced about 0.02 in deviation, compared with the treatment method of the comparative example. In the case of dispersion management for accuracy of mass production articles and the like, in general, the dispersion is evaluated by the value of [mean value −4×deviation]. Therefore, the difference of about 0.02 in deviation represents a significant difference in terms of the dispersion management.

It can be considered that the stabilization of the depth of the refined layer (restriction of dispersion) is caused by a work temperature dispersion reduction effect at the time of treating each space between valve ports due to the fact that a long treating path running through all cylinders is not provided and each treating path is independently provided for each cylinder.

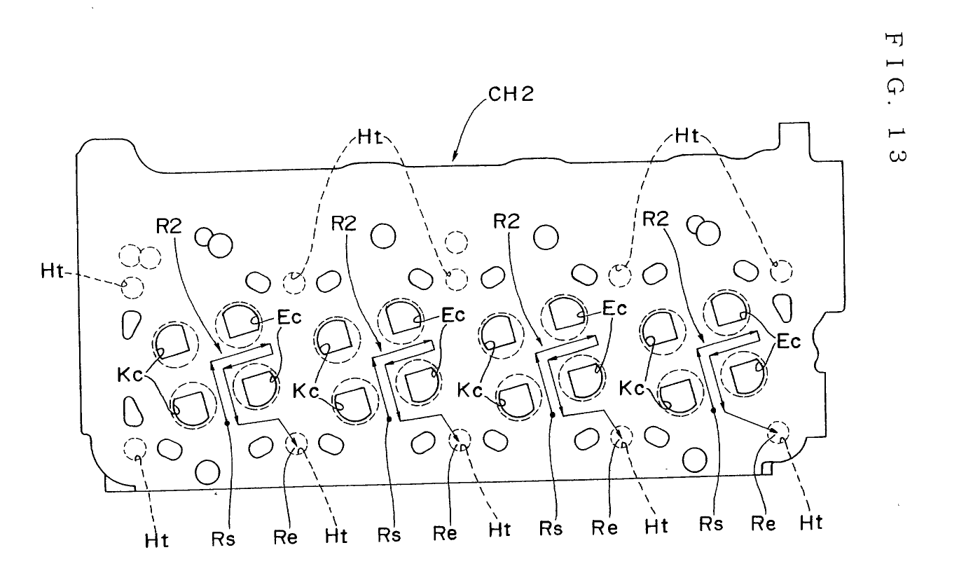

A surface treatment method by a frictional stirring treatment for space between valve ports of a direct injection diesel engine cylinder head casting member of a in-line type with four cylinders as described above is not limited to one including the treating paths R1 shown in FIG. 5. For example, as a cylinder head CH2 shown in FIG. 13 (second embodiment), a treating path R2 for implementing the surface treatment only for two space between valve ports may be independently set for each cylinder. In the second embodiment, the treating path is set for a space between valve ports that is between an intake port Kc and an exhaust port Ec in the side where a glow plug mounting hole is provided and a space between valve ports that is between exhaust ports.

This case also can produce an effect similar to that of the case of the first embodiment shown in FIG. 5 in terms of treatment time, treatment depth, and dispersion restriction, compared with Comparative Example 1 shown in FIG. 15.

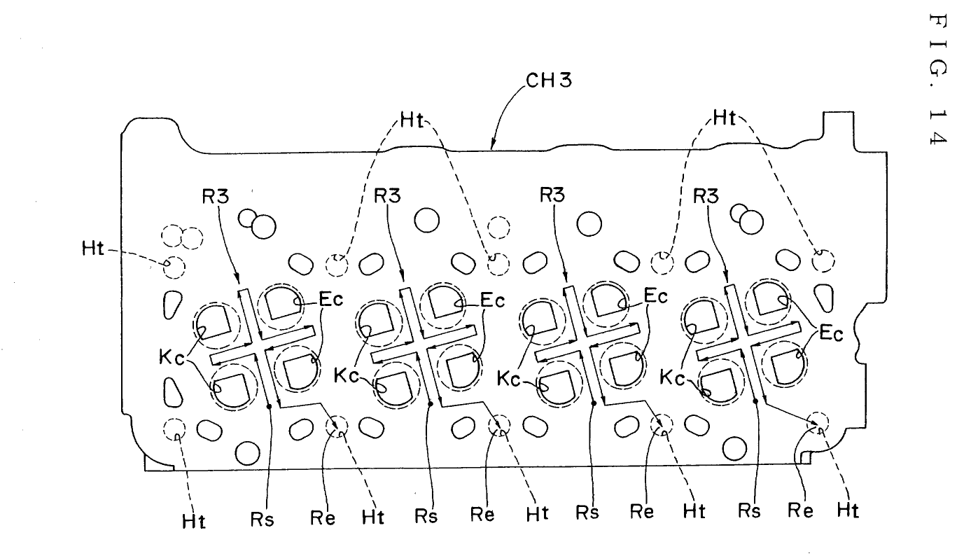

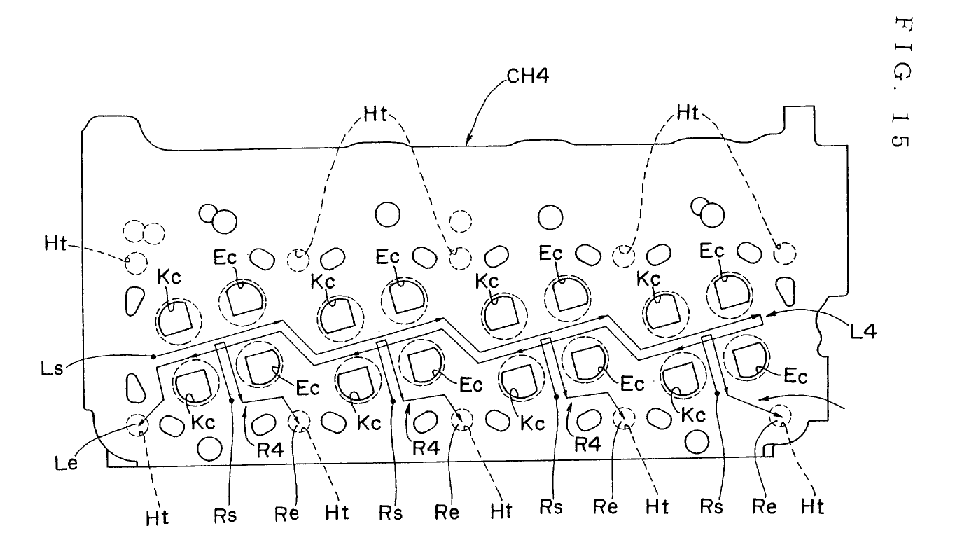

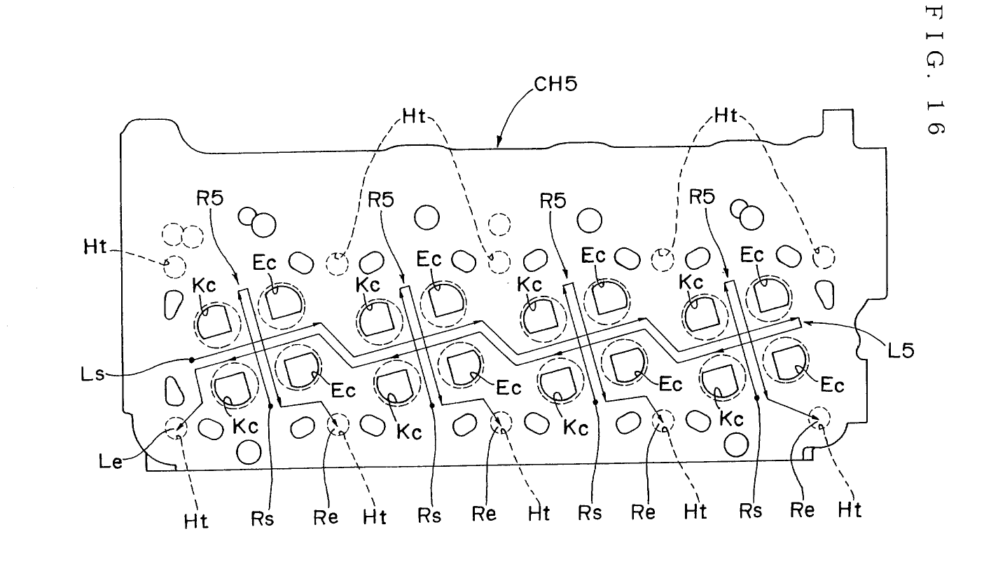

Further more, as a cylinder head CH3 shown in FIG. 14 (third embodiment), a treating path R3 for implementing the surface treatment for all spaces between valve ports of four ports composed of a pair of intake ports Kc and a pair of exhaust ports Ec may be independently set for each cylinder.

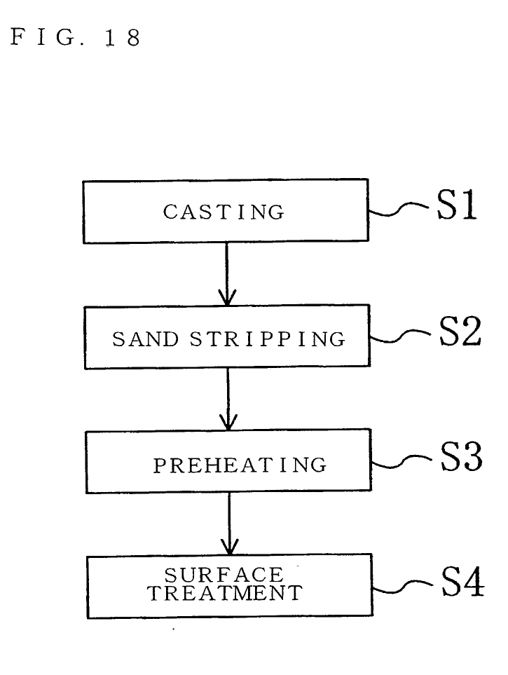

In this case, compared with a case where a long treating path L5 running through all cylinders is provided in addition to treating path R5 for the respective cylinders for treating a space between valve ports that is between an intake port Kc and an exhaust port Ec in the side where a glow plug mounting hole is not provided, that is, as a cylinder head CH4 according to Comparative Example 2 shown in FIG. 16, it is possible to shorten the treatment time, increase the mean value of treatment depth, and restrain the dispersion of the treatment depth.

Next, a fourth embodiment of the present invention will be explained below.

It is to be noted that, in the explanation below, the same numerals are affixed to those having structures and functions similar to those in the preceding embodiment, and further explanation is omitted.

FIG. 17 is a front view of a rotational tool 20 which is employed to conduct a surface treatment according to the fourth embodiment of the present invention.

The rotational tool 20 is provided with major portions similar to the tool 10 shown in FIG. 1. That is, the rotational tool 20 is provided with a rotational base portion 21 of a column with a predetermined diameter and a probe portion 22 of a column which is integrally fixed on a central portion of an end of the base portion 21. The rotational tool 20 is also provided with a shank 23 integrated with the base portion 21. The shank 23 is to be rotatably supported about the axis thereof by means of a holder 51 provided with an apparatus for frictional stirring treatment. The holder 51 is rotatably driven by a tool driving means 5 (refer to FIG. 1) so that the rotational tool 20 is rotated about the axis.

The probe portion 22 has a predetermined length and a relatively small diameter (smaller than that of the rotational base portion 21). And, in the embodiment, screw thread cutting of an external screw is given on the outer periphery of the probe portion 22, for example. The screw thread is formed as a left-hand screw thread whose tightening direction is opposite to that of the rotational tool 20, for example.

It is to be noted that, as same as preceding embodiments, the rotational tool 20 is not limited to one which is provided with the small diameter probe portion 12 on an end portion (lower end portion) of the rotational base portion 21 as shown in FIG. 17. Also, the rotational base portion 21 is not limited to the column-shaped-one shown in FIG. 17, and various features of the probe portion can be employed.

FIG. 18 is a flow chart describing a process of a surface treatment for a cylinder head according to the fourth embodiment of the present invention.

In a first step S1, a cylinder head is cast by using shell cores to form hollow portions such as intake and exhaust ports, water jacket portions and the like.

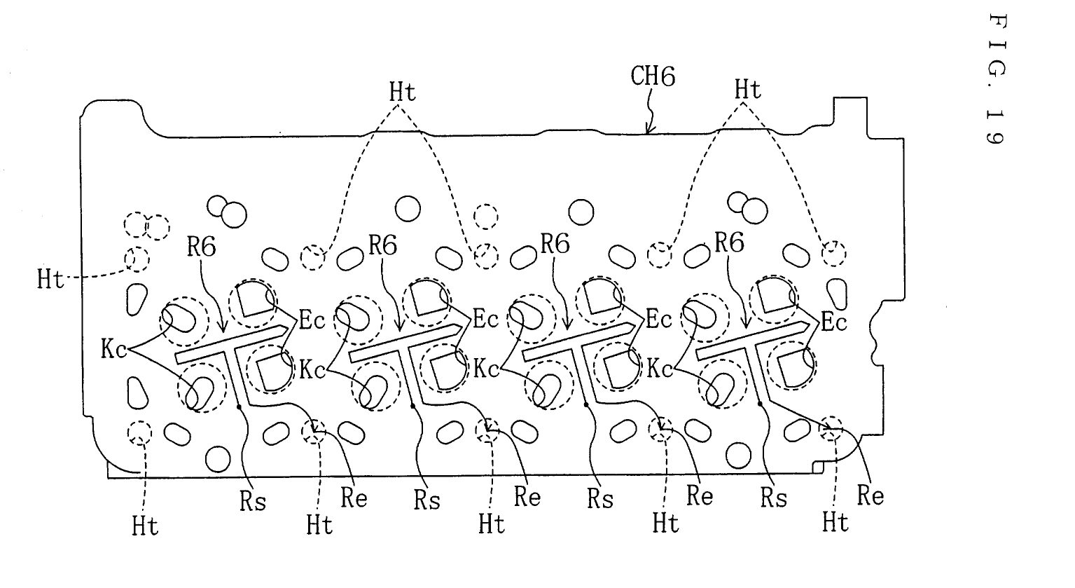

FIG. 19 is a plan explanatory view schematically illustrating a mating face with a cylinder block of a casting member for a cylinder head according to the fourth embodiment of the present invention.

As shown in this figure, the cylinder head CH6 is for a diesel engine of in-line type with four cylinders and has very similar constitution as those CH1, CH2, CH3 in preceding embodiment. The cylinder head CH6 has an almost same construction as those CH1, CH2, CH3 in preceding embodiment, except for the shape of intake ports in the state of casting holes. In the case of the cylinder head CH6, each shape of intake and exhaust ports are different to each other. That is, each of the intake ports has a shape of substantially elongated hole, and each of the exhaust ports has a shape of substantially a quarter of a circle.

As a light alloy material for the cylinder head CH1, for example, aluminum alloy AC4D prescribed in JIS (Japanese Industrial Standard) is employed. The chemical compositions of aluminum alloy AC4D are as follows:

Cu: 1.0-1.5 wt %; Si: 4.5-5.5 wt %; Mg: 0.4-0.6 wt %; Zn: not more than 0.10 wt %; Fe: not more than 0.40 wt %; Mn: not more than 0.10 wt %; Ni: not more than 0.20 wt %; Ti: not more than 0.10 wt %; Pb: not more than 0.10 wt %; Sn: not more than 0.05 wt %; Cr: not more than 0.15 wt %; Ca: not more than 0.008 wt %; Al: Remainder.

It is to be noted that, instead of the above-mentioned AC4D, the other aluminum alloy AC4B, or AC2B, or AC8A or the like can be employed.

In a second step S2 shown in the flow chart of FIG. 18, a sand stripping for removing core sand from casting member. In this step, a T6 heat treatment (a solution heat treatment and an aging treatment) is applied to the cast cylinder head CH6, in order to heat the core sand inside the casting.

That is, in detail, the cylinder head CH6 is heated at a temperature range of 535±5 degrees centigrade during 4-10 hours, and thereafter, it is cooled rapidly to a temperature range of 90-99 degrees centigrade. Thereby, the cylinder head H6 is brought into a solution heat-treated condition.

Next, an artificial aging (a high temperature aging) is conducted as an aging treatment for the cylinder head H6. That is, the cylinder head CH6 is heated at a temperature range of 180±5 degrees centigrade during 4-10 hours.

The heating temperature for core sand must be not less than 400 degrees centigrade in which resin binder of shell core is carbonized by heating. It is possible to enhance the strength and the hardness of the cylinder head CH6, by conduct such a T6 heat treatment.

In a third step S3, the cylinder head CH6 is subject to a preheat treatment in which it is heated in an electric furnace. In the preheat treatment, the heating temperature is set preferably to a range of 150-180 degrees centigrade, and heating duration is set preferably to a range of 5-10 minutes.

The lower limit of the preheating temperature set to 150 degrees centigrade in this case is due to fact that, although the residual stress of the cylinder head CH6 is reduced, the dispersion of the residual stress is possibly larger, when the heating is lower than 150 degrees centigrade. On the other hand, the higher limit of the preheating temperature set to 180 degrees centigrade in this case is due to fact that the cylinder head is softened by over aging when preheating temperature is higher than 180 degrees centigrade.

Duration of preheating is set to a range of 5-10 minutes so that a suitable preheating condition is kept while preventing too much energy consumption. The lower limit of the duration of preheating set to 5 minutes in this case is due to fact that a sufficient preheating can not be achieved when the duration is less than 5 minutes. On the other hand, the higher limit of the duration of preheating set to 15 minutes in this case is due to fact that, although a sufficient preheating can be achieved, required energy for the preheating become too much when the duration is longer than 5 minutes.

Next, in a fourth step S4, a surface treatment is applied to the preheated cylinder head CH6.

In the present embodiment, as shown in FIG. 19, the surface treatment by the above-mentioned frictional stirring treatment method is applied to at least the surface part between intake and exhaust ports (space between valve ports) in the cylinder head CH6. The basic patterns of the treating paths for the cylinder head CH6 is the same as that for the cylinder head CH1 of the first embodiment shown in FIG. 5.

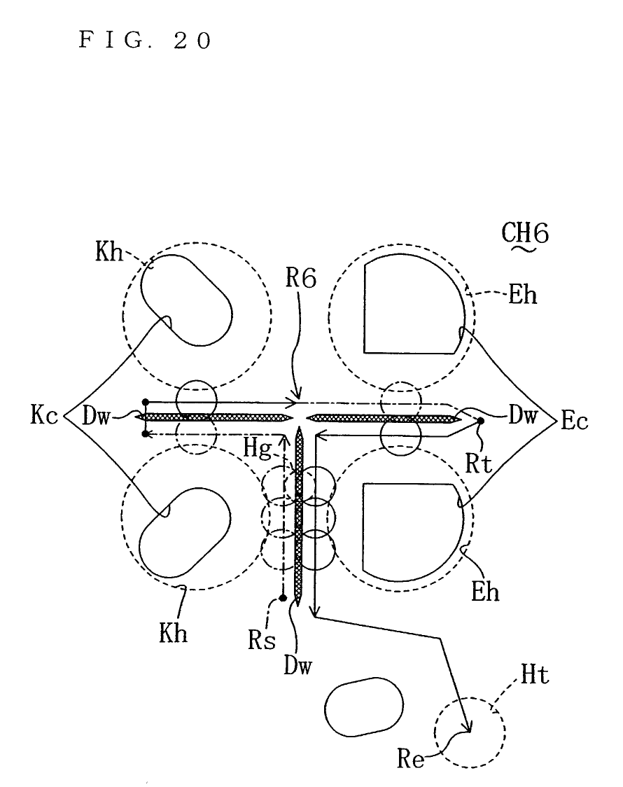

That is, a treating path R6 of the frictional stirring treatment is independently set for each cylinder, and a long treating path running through all cylinders as in the prior art method is not provided. Also, the patterns of the respective treating paths R6 each of which is independently set for each cylinder are substantially the same for all cylinders. Further, as shown in detail in FIG. 20, the treating path R6 is set as an approximately T-shape pattern in plane view (refer to straight lines to which arrows are affixed in FIG. 20). Further more, the basic pattern of the treating path R6 and the number and the position of the glow plug mounting hole Hg are the same as that of the first embodiment shown in FIG. 6. Further more, the each width of the space between valve ports is preferably set to the same dimension as that of the first embodiment.

Further more, as shown by line segments with arrows in FIG. 20, forward and backward paths are set in the treating path R1 among the intake and exhaust ports (space between valve ports) of each cylinder. The forward path and the backward path are set to be parallel to each other. Specifically, the forward and backward paths of the treating path R1 of said space between valve ports are set in such a way that at least part of the rotating region of the rotational tool 20 overlaps as same as in FIG. 7 (overlap region: Dw).

In the present embodiment, turning paths connecting the end point of the forward path with the start point of the backward path are set in the space between the intake ports Kc and the space between the exhaust ports Ec. Regarding the turning path provided with the space between the intake ports Kc, there are provided with two of turning points at which the travelling direction of the rotational tool 20 is changed by 90 degrees. These turning points are set to the end point of the forward path and the start point of the backward path respectively.

On other hand, regarding the turning path provided with the space between the exhaust ports Ec, there is provided with only one turning point Rt at which the travelling direction of the rotational tool 20 is changed from a travelling direction along the forward path to a travelling direction along the backward path. This turning point Rt is set at a position of equal distance from each of a pair of the exhaust ports Ec, Ec. That is, the turning point Rt is positioned on a line extending through the center between the exhaust ports Ec and extending in a longitudinal direction of the cylinder head CH6. Further, a path between the end point of the forward path and the turning point Rt, and a path between the turning point Rt and the start point of the backward path are set to be substantially straight line paths respectively. Thereby, the pattern of the turning path is set to be tapered shape which tapers toward the turning point Rt.

The surface treatment is performed continuously from a treatment start portion Rs to a treatment end portion Re for each cylinder in the pattern of the treating path R6.

In the surface treatment at the fourth step S4, the position of the rotational tool 20 is first set at the treatment start portion Rs and is advanced along dashed lines with the start of the treatment. That is, at first, the space between valve ports that is between an intake port Kc and an exhaust port Ec and that is of the side in which the glow plug mounting hole Hg is provided is treated (treatment of the forward path). Then, a 90 degrees direction change is made to treat the space between valve ports that is between the intake ports Kc. Next, the rotational tool 20 makes 90 degrees direction changes respectively at the two turning points provided with the space between valve ports that is between the intake ports Kc. And thereafter, the tool treats the space between valve ports that is between the intake ports Kc along the solid lines once again (treatment of the backward path).

Further, the tool enters the space between valve ports that is between the exhaust ports Ec to treat this space between valve ports along the dashed lines (treatment of the forward path). Then, the tool changes the travelling direction thereof slightly and moves toward the turning point Rt. And thereafter, the tool turns the travelling direction thereof at the turning point Rt. Further, the tool is advanced along the solid lines to treat the space between valve ports that is between the exhaust ports Ec once again (treatment of the backward path), and then makes a 90 degrees direction change to treat the space between valve ports that is between an intake port Kc and an exhaust port Ec and that is of the side in which the glow plug mounting hole Hg is provided once again (treatment of the backward path).

After finishing the surface treatment for the space between valve ports, the rotational tool 20 is moved up to the processing end portion Re in the pattern of the treating path R6 as an end hole treatment, and the rotation of the tool 20 is stopped at the end portion Re so that the tool 20 is lifted upward. This end portion Re of the surface treatment is set so as to correspond to approximately the center of a drilling portion of the tension bolt-hole Ht whose position is set near the cylinder portion. Since this portion is drilled by machining process to be removed after the surface treatment for the space between valve ports as described above, even after the end hole treatment of the frictional stirring treatment is executed, the end hole does not remain in a final product. This is the same as the cylinder head CH1 in the first embodiment.

The rotational tool 20 is to be controlled by a controller (not shown) with a control unit as same as that in the first embodiment. And setting of the treatment depth with respect to a work surface part, a movement locus on a work surface, and the like are automatically set in accordance with a command signal from the controller based on a predetermined control program.

According to the fourth embodiment, basically the same effect as that of the first embodiment can be obtained. That is, the treatment time of the frictional stirring treatment can be drastically shortened, and treatment efficiency can be considerably enhanced, without fear that dispersion among cylinders occurs regarding the treatment depth of the surface treatment, because the treating path R6 of the frictional stirring treatment is independently set for each cylinder, and a long treating path running through all cylinders is not provided. Also, the frictional stirring treatment work can be easy and stable, because the respective pattern of the treating path R6 independently set for each cylinder is set so as to be substantially the same for all cylinders.

Further, the forward and backward paths are set in the treating path R1 of the space between valve ports of each cylinder, and repeated treatment is executed on both forward and backward paths, thereby, the surface treatment can be executed effectively covering the entire width thereof. Furthermore, since treatment is continuously executed from the start portion Rs to the end portion Re in the treating path pattern R1 for each cylinder, a high treatment efficiency can be maintained.

Furthermore, since an overlapped treatment by the forward and backward paths is executed for an approximately central region in the width direction of the space between valve ports, deeper and more effective surface treatment can be executed for the region Dw.

Further more, by setting the pattern of the treating path R1 in such a way that the intake and exhaust ports Kc, Ec are positioned in sides adjacent to a leading side with respect to the rotation of the rotational tool 20 which correspond to the same directions as the advancing directions of the rotational tool 20, that is, by setting in such a way that a neighboring port is always positioned in the left side in the case where the rotation direction of the tool 20 is clockwise, the region B1 having small treatment area is caused to exist in a thin-walled side of the port end as schematically shown in FIG. 12, whereby a required treatment depth is ensured, and deformation of a port end is restrained. The difference in the treatment areas and the plastic flow depths due to the combination of the travel direction and the rotation direction of the rotational tool 20 is exhibited very remarkably in the case where the probe portion of the rotational tool 20 is of a type in which thread grooves of an external thread are provided on the outer periphery.

Furthermore, according to the fourth embodiment, it is possible to restrain the generation of residual stress on the cylinder head CH6 after the surface treatment, by preheating the cylinder head CH6 prior to the surface treatment.

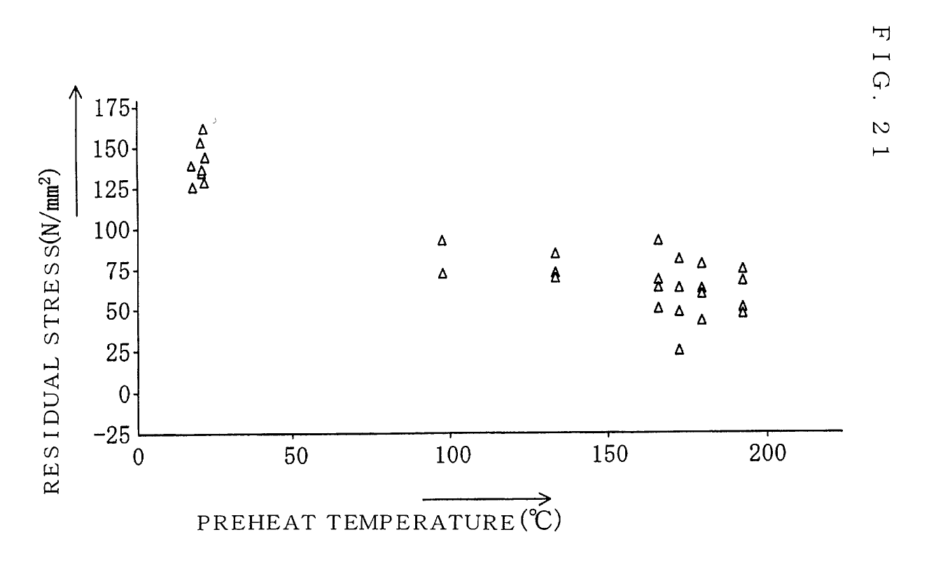

FIG. 21 shows a measurement result of residual stress on the cylinder head CH6 with and without a preheat treatment. In the case that a preheat treatment is not applied (preheat temperature is about 30 degrees centigrade, that is, room temperature), difference of the temperature between portions softened and caused plastic flow by rotational tool in the surface treatment (plastic flow layer) and the surrounding portions thereof is large. Thereby thermal stress (strain) is generated on the cylinder head CH6. As seen from FIG. 21, generated thermal stress causes residual stress of about 122-167 N/mm².

On other hand, in the case that a preheat treatment is applied (preheat temperature is about 150-180 degrees centigrade), generated residual stress is about 22-77 N/mm². Thus, residual stress is drastically reduced. It is considered that, in the case that a preheat treatment is applied, difference of the temperature between plastic flow layer and the surrounding portions thereof is small, thereby residual stress on the cylinder head CH6 is restrained.

Thus, according to the fourth embodiment, the cylinder head CH6 is preheated prior to the surface treatment. Thereby, generation of residual stress is restrained, and thermal fatigue strength is enhanced. Further, resistance by the cylinder head CH6 to rotational tool in the surface treatment is reduced by the preheat treatment. Thereby, required energy for frictional stirring is reduced, and durability of the rotational tool 20 is improved.

Further more, in the present embodiment, only one turning point Rt of a turning path is set in a space between valve ports that is between the exhaust ports Ec, and the turning point Rt is located at a position far from edge of the exhaust port Ec. Thereby, it is possible to restrain temperature rising in the space between said valve ports during the surface treatment, and to restrain deformation at the edge of the exhaust port Ec adjacent to the space between said valve ports. Specifically, in the present embodiment, Young's modulus of the material is lowered by preheat treatment, accordingly a port edge is apt to cause deformation. However, by setting the turning path to such a shape, deformation at the port edge is restrained. Thus, it is possible to restrain generation of unfilled defects inside treated area.

Implemented was comparative examination for comparing a surface treatment method for a space between valve ports of a cylinder head CH6 according to the present embodiment and a surface treatment method for a space between valve ports of a cylinder head according to a comparative example. Next, this comparative examination is explained.

In the explanation below, the same numerals are affixed to those having structures and functions similar to those in the case of the cylinder head CH6 according to the fourth embodiment, and further explanation is omitted.

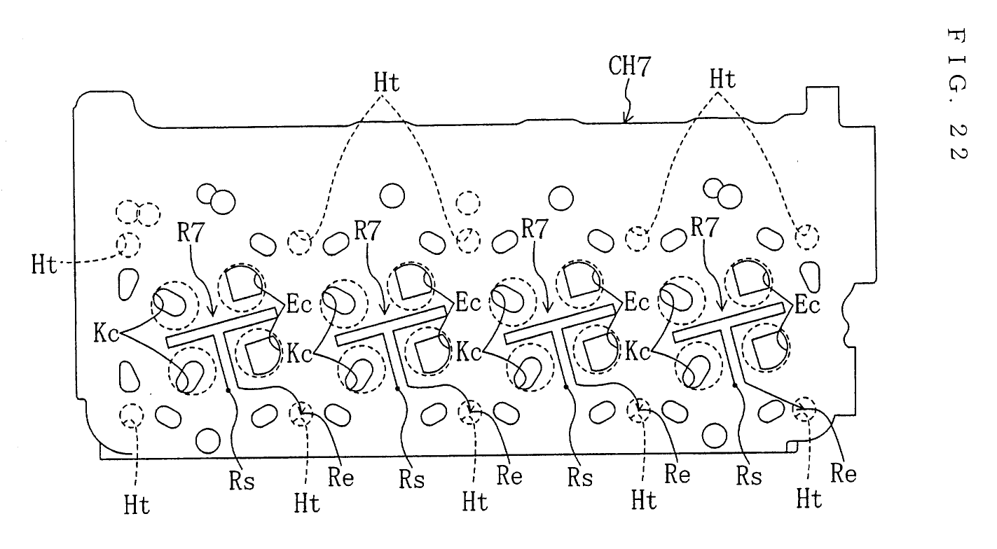

FIG. 22 is a plan explanatory view schematically illustrating a mating face for a cylinder block of a casting member for a cylinder head CH7 according to Comparative Example. As shown in this drawing, in the cylinder head CH7 of this Comparative Example, two turning points which is to turn the travelling direction of the rotational tool 20 by 90 degrees are set on a turning path provided with the space between valve ports that is between the exhaust valve ports Ec, in a surface treating paths R7. Those turning points are set to an end point of the forward path and a start point of the backward path. That is, the turning path provided with the space between the exhaust ports Ec has the same shape as the turning path provided with the space between the intake ports Kc.

In this comparative examination, in order to clarify difference in treatment results due to the difference of the treating paths, the surface treatment for the space between valve ports of both cylinder heads CH6, CH7 was executed, employing the same treatment apparatus including the rotational tool 20, the shape of the probe portion, and the like under the same frictional stirring treatment conditions. Also, in this comparative examination, a type of the probe portion 22 shown in FIG. 17 is employed. That is, thread grooves of an external thread are provided on the outer periphery of the prove portion as shown in FIG. 17. The treatment was executed while setting was done in such a way that the probe portion 22 of the thread grooves of a left-handed screw is rotated in a clockwise direction. Further, rotational speed of the rotational tool is set to 700 rpm, and travelling speed thereof is set to 500 mm/minute. Further more, the shoulder 21 of the rotational tool 20 is set to intrude into the surface part of the cylinder head by 0.75 mm. Thereby, intrusion amount of the rotational tool 20 is set to 5.55 mm (4.8 mm+0.75 mm). It is to be noted that, in this case, the length of the probe portion 22 is set to 4.8 mm.

A plurality of direct injection diesel engine cylinder head casting members of the in-line type with a series four cylinder were prepared as test products. They were manufactured using the same material and specifications. Also, they are preheated prior to the surface treatment, as described above. With respect to half members of them, the surface treatment was conducted along the treating path R6 shown in FIG. 19, as the present embodiment. And, with respect to remaining half members, the surface treatment was conducted along the treating paths R7 shown in FIG. 22, as the comparative example.

Thereafter, the treatment depth of frictional stirring treatment and occurrence ratio of unfilled defects in each space between valve ports were examined to be compared. These examinations were sampling ones with each three pieces of samples from present embodiment and comparative example respectively.

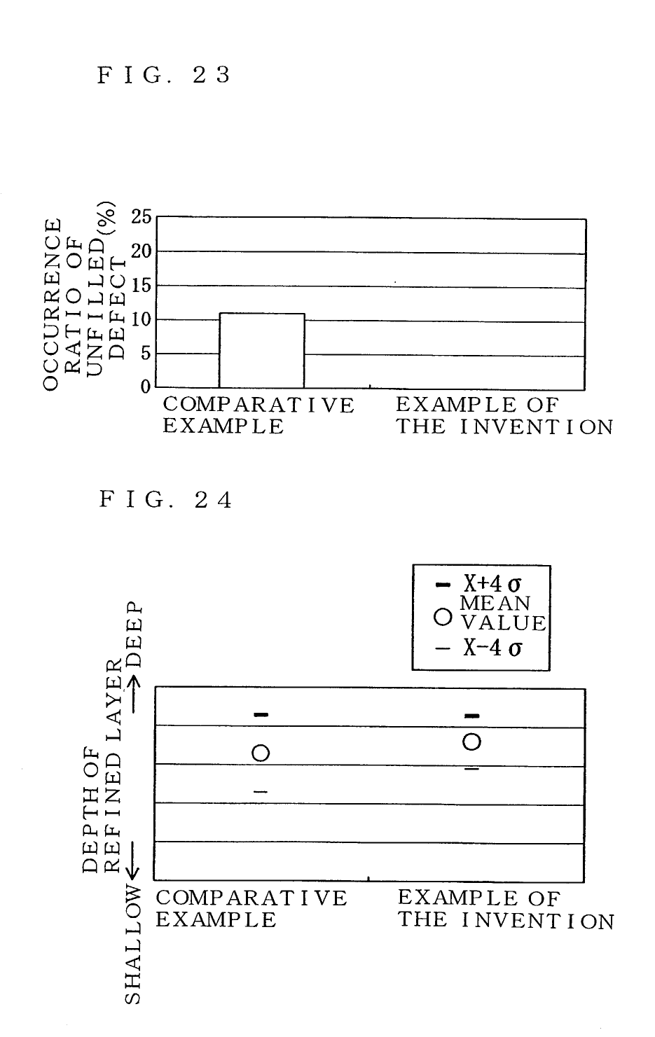

At first, occurrence ratio of unfilled defects was examined. The treated surfaces of the respective samples for which the surface treatment has been completed were machined by milling for about 2 mm. Thereafter, the treated portions by the frictional stirring treatment were cut, and the cut surfaces were polished to observe the micro-structure of the texture. The microscopic observation for the polished cut surface was executed with a magnification of 50, employing a metallurgical microscope. Test result is shown in FIG. 23.

According to the test result, with regard to the comparative example, although no unfilled defects can be observed in the space between the intake ports Kc and between the intake port Kc and the exhaust port Ec, small unfilled defects are observed in the space between the exhaust ports Ec. Occurrence ratio of unfilled defects was 11% in the treatment method of the comparative example. On the other hand, with regard to the embodiment example, no unfilled defects can be observed in all of the space between valve ports. That is, occurrence ratio of unfilled defects was 0% in the treatment method of the present embodiment. It may be considered that deformation at the edge of the exhaust ports Ec is restrained by setting the number of turning point Rt to only one and setting the location of the turning point Rt to a position far from the exhaust ports Ec.

Further, The measurement of the depth of the refined layer about the polished cut surface was conducted by employing a profile projector at a magnification of 20. This measurement of the depth of the refined layer is conducted at four portions of the spaces between the exhaust ports Ec for each sample. Test result is shown in FIG. 24.

According to the test result, by adopting the treatment method of the present embodiment, difference of the value of [mean value ±4×deviation] is smaller than that in the treatment method of the comparative example. That is, it is possible to restrain the dispersion in the depth of the refined layer by adopting the treatment method of the present embodiment. It is to be noted that, in the case of dispersion management for accuracy of mass production articles and the like, in general, the dispersion is evaluated by the value of [mean value −4×deviation].

It can be considered that the stabilization of the depth of the refined layer (restriction of dispersion) is caused by a work temperature dispersion reduction at the vicinity of the turning path due to the fact that only one turning point Rt is set on the turning path in the present embodiment.

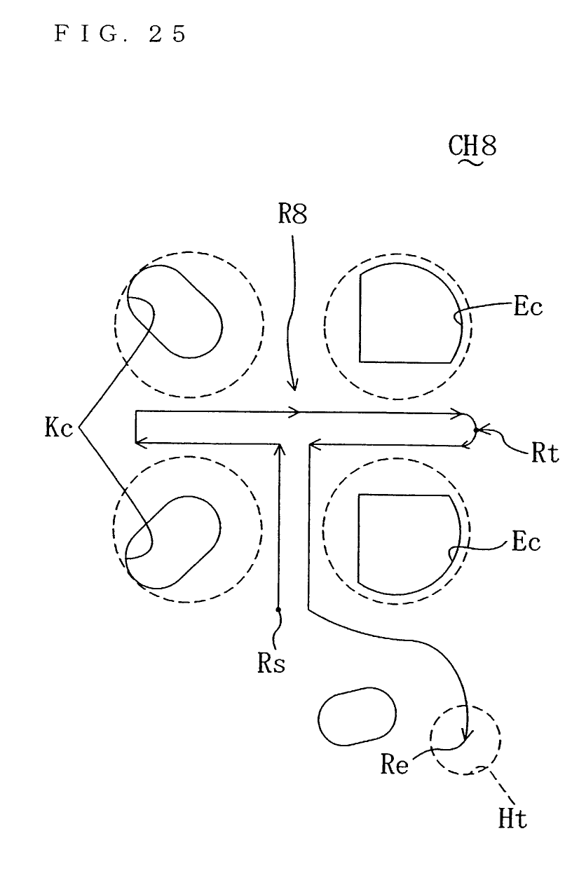

FIG. 25 shows a treating path R7 for a cylinder head CH7 according a fifth embodiment of the present invention.

In the treating path R7 according the fifth embodiment, regarding the turning path provided with the space between the exhaust ports Ec, there is provided with only one turning point Rt. This turning point Rt is set at a position of equal distance from each of a pair of the exhaust ports Ec, Ec. The number of the turning point Rt and the location thereof are the same as in the fourth embodiment.

However, a path between the end point of the forward path and the turning point Rt, and a path between the turning point Rt and the start point of the backward path are set to be substantially arc paths respectively. Thereby, the pattern of the turning path is set to be substantially semi-circular shape as a whole.

In this case, the same effect as those of the fourth embodiment can be achieved. That is, it is possible to restrain the deformation at the edge of the exhaust port and reduce the occurrence of unfilled defects inside the treated area. Further, dispersion in the treatment depth is restrained, in the space between the exhaust ports Ec.

In the fourth and fifth embodiments, there is provided with only one turning point Rt on the turning path provided with the space between the exhaust ports Ec, and there are provided with two turning point (turning point at which the travelling direction on the rotational tool 20 is changed by 90 degrees) on the turning path provided with the space between the intake ports Kc. This is because the shape of the intake port Kc differs from that of the exhaust port Ec in those embodiment. That is, in those embodiments, as shown in FIG. 20, the distance between the edge of the intake port Kc and the turning point is relatively long. Thereby, the deformation at the edge of the intake port Kc is hard to occur even when temperature of the vicinity of the turning point is raised up during the surface treatment. Accordingly, in the fourth and fifth embodiments, there are provided with two turning point on the turning path provided with the space between the intake ports Kc. However, there may be provided with only one turning point Rt on the turning path provided with the space between the intake ports Kc also, as same as on the turning path provided with the space between the exhaust ports Ec.

Although the respective embodiments above are for a cylinder head in which an aluminum alloy is employed as a material, the present invention can be effectively applied to the case where another light metal such as for example magnesium and its alloy is employed as a material.

A cylinder head is not limited to one for a direct injection diesel engine and may be one employed in another type of engine, and is not limited to one of in-line type with four cylinders or one of multiple cylinder type.

Further, although the embodiments above are for cases where only space between valve ports of a cylinder head are given the surface treatment, the present invention is not limited to such cases, and other required surface part other than space between valve ports may also be given the surface treatment by the frictional stirring treatment.

As described above, the present invention is not limited to the embodiments above, and it is needless to say that various improvements or modifications in design are possible without departing from the scope or spirit of the invention.

What is claimed is:

1. A surface treatment method for a light alloy cylinder head of a multiple cylinder engine having a plurality of intake and exhaust ports for each cylinder, in which a frictional stirring treatment is applied to at least a surface part between the intake and exhaust ports by using a predetermined rotational tool,
wherein a treating path of the frictional stirring treatment corresponding to a movement locus of the rotational tool approximately along cylinder head surface is independently set for each cylinder.

2. The surface treatment method for the cylinder head as set forth in claim 1, wherein a pattern of the treating path which is independently set for each cylinder is substantially the same for all cylinders.

3. The surface treatment method for the cylinder head as set forth in claim 1, wherein a forward path and a backward paths are set in the treating path between the intake and exhaust ports of each cylinder, and the treatment is continuously executed for each cylinder from a treatment start portion to an end portion in the pattern of the treating path.

4. The surface treatment method for the cylinder head as set forth in claim 3, wherein the pattern of the treating path is set in such a way that the intake and exhaust ports are positioned in sides adjacent to a leading side with respect to a rotation of the rotational tool which correspond to the same direction as an advancing direction of the rotational tool.

5. The surface treatment method for the cylinder head as set forth in claim 3, wherein the forward path and backward path of the treating path between the intake and exhaust ports are set so that rotating regions of the rotational tool in the forward and backward paths are overlapped.

6. The surface treatment method for the cylinder head as set forth in claim 4, wherein the multiple cylinder engine is a diesel engine having a pair of intake ports and a pair of exhaust ports for each cylinder, and the treating path is set as an approximately T-shape pattern in a plan view so as to treat respective surface parts of a region having a relatively narrow space among portions between intake and exhaust ports and a region in which a glow plug mounting hole is provided.

7. The surface treatment method for the cylinder head as set forth in claim 1,
wherein the treating path being set between the intake and exhaust ports is provided with a forward path and a backward path set to be parallel to each other and a turning path connecting a end point of the forward path with a start point of the backward path, the turning path is provided with a turning point at which the travelling direction of the rotational tool is changed, and
wherein the turning point is set at a position of equal distance from each of a pair of the intake and exhaust ports adjacent to the treating path.

8. The surface treatment method for the cylinder head as set forth in claim 7, wherein a path between the end point of the forward path in the turning path and the turning point, and a path between the turning point and the start point of the backward path in the turning path are set to be substantially straight line paths respectively.

9. The surface treatment method for the cylinder head as set forth in claim 7, wherein a path between the end point of the forward path in the turning path and the turning point, and a path between the turning point and the start point of the backward path in the turning path are set to be substantially arc paths respectively.

10. The surface treatment method for the cylinder head as set forth in claim 7, wherein the forward path and backward path of the treating path between the intake and exhaust ports are set so that rotating regions of the rotational tool in the forward and backward paths are overlapped.

11. The surface treatment method for the cylinder head as set forth in claim 7, wherein the treating path is independently set for each cylinder, and the surface treatment is continuously executed for each cylinder from a treatment start portion to an end portion in the pattern of the treating path.

12. The surface treatment method for the cylinder head as set forth in claim 7, wherein the method includes a preheating process in which a cast cylinder head is heated to a predetermined temperature, and the surface treatment process for the cylinder head is performed after the preheating process for the cylinder head.

13. The surface treatment method for the cylinder head as set forth in claim 12, wherein the cylinder head is heated at a range of 150-180 degrees centigrade in the preheating process.

14. A light alloy cylinder head of a multiple cylinder engine having a plurality of intake and exhaust ports for each cylinder and in which surface treatment by a frictional stirring treatment is applied to at least a surface part between the intake and exhaust ports by using a predetermined rotational tool,
wherein a surface treatment part is formed independently for each cylinder in accordance with a treating path of the frictional stirring treatment corresponding to a movement locus of the rotational tool approximately along cylinder head surface.

15. The cylinder head as set forth in claim 14, wherein the multiple cylinder engine is a diesel engine having a pair of intake ports and a pair of exhaust ports for each cylinder, and the surface treatment part is formed as an approximately T-shape pattern in a plan view by a treatment region having a relatively narrow space among portions between intake and exhaust ports and a treatment region in which a glow plug mounting hole is provided.

16. A light alloy cylinder head of a diesel engine which is provided with a cylinder having a pair of intake ports and a pair of exhaust ports and in which surface treatment by a frictional stirring treatment is applied to at least a surface part between the intake and exhaust ports by using a predetermined rotational tool,
wherein a surface treatment part is formed as an approximately T-shape pattern in a plan view by a treatment region having a relatively narrow space among portions between intake and exhaust ports and a treatment region in which a glow plug mounting hole is provided.
